(19) United States
(12) Patent Application Publication
(10) Pub. No.: US 2026/0215380 A1
(43) Pub. Date: Jul. 30, 2026

(54) TOWER INDEXING VIA TOWER INTERLEAVING

(71) Applicant: MJNN LLC, South San Francisco, CA (US)

(72) Inventor: Paul Bryan Kreiner, Menlo Park, CA (US)

(73) Assignee: MJNN LLC, South San Francisco, CA (US)

(21) Appl. No.: 19/142,005

(22) PCT Filed: Dec. 26, 2023
(86) PCT No.: PCT/US2023/085909

§ 371 Date: Jun. 20, 2025

Related U.S. Application Data
(60) Provisional application No. 63/477,348, filed on Dec. 27, 2022.
(60) Provisional application No. 63/492,634, filed on Mar. 28, 2023.
(60) Provisional application No. 63/609,647, filed on Dec. 13, 2023.

(51) Int. Cl. A01G 31/02

(52) U.S. Cl. CPC A01G 31/022; A01G 31/024; A01G 31/025

(57) ABSTRACT

Systems and methods for transforming a first set of first plant support structures and a second set of second plant support structures from a high density arrangement to a low density arrangement are provided. The system deinterleaves the first and second sets to thereby move from the high density arrangement, in which the first and second sets are interleaved such that at least one second plant support structure is interposed between two first plant support structures, to the low density arrangement, in which the first and second sets are not interleaved.

This application claims the benefit of priority to U.S. Provisional Application Nos. 63/477,348, filed 27 Dec. 2022, 63/492,634, filed 28 Mar. 2023, and 63/609,647, filed Dec. 13, 2023. This application is also related to U.S. application Ser. No. 17/585,409, filed 4 Apr. 2022, which is a continuation-in-part of U.S. application Ser. No. 17/327,479, filed 21 May 2021, which claims the benefit of priority to U.S. Provisional Application No. 63/028,960, filed 22 May 2020. This application is also related to U.S. Application No. 63/376,589, filed 21 Sep. 2022, which is related to U.S. application Ser. No. 15/910,445, filed 2 Mar. 2018, which is a continuation in part of U.S. application Ser. No. 15/910,308, filed 2 Mar. 2018, and is related to PCT/US22/73896, filed 19 Jul. 2022, which claims the benefit of priority to U.S. Application Nos. 63/224,083, filed 21 Jul. 2021, 63/267,974, filed 14 Feb. 2022, and 63/362,471, filed 5 Apr. 2022. All of the foregoing are incorporated by reference herein.

### BACKGROUND

### Field of the Disclosure

The disclosure relates generally to the field of agriculture, and, particularly, to indexing plant support structures (e.g., vertical towers) to accommodate the growth of plants in the structures.

### Description of the Related Art

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

During the twentieth century, agriculture slowly began to evolve from a conservative industry to a fast-moving high-tech industry in order to keep up with world food shortages, climate change, and societal changes. Farming began to move away from manually-implemented agricultural techniques toward computer-implemented technologies. Conventionally, farmers only have one growing season to produce the crops that would determine their revenue and food production for the entire year. However, this is changing. With indoor growing as an option, and with better access to data processing technologies and other advanced techniques, the science of agriculture has become more agile. It is adapting and learning as new data is collected and insights are generated.

Advancements in technology are making it feasible to control the effects of nature with the advent of “controlled indoor agriculture,” otherwise known as “controlled environment agriculture” or “CEA.” Improved efficiencies in space utilization and lighting, a better understanding of hydroponics, aeroponics, and crop cycles, and advancements in environmental control systems have allowed humans to better recreate environments conducive for agriculture crop growth with the goals of greater harvest weight yield per square foot, better nutrition and lower cost.

US Patent Publication Nos. 2018/0014485 and 2018/0014486, both assigned to the assignee of the present disclosure and incorporated by reference in their entirety herein, describe environmentally controlled vertical farming systems. The vertical farming structure (e.g., a vertical tower) may be moved about an automated conveyance system in an open or closed-loop fashion, exposed to precision-controlled lighting, airflow and humidity, with ideal nutritional support.

US2021/0084850A1 describes a vertical farm irrigation system in which a grow tower conveyance system moves vertically-oriented grow towers to select positions along a grow line. As plants grow, it is desirable to provide them more space in the growing environment.

### SUMMARY OF THE DISCLOSURE

In some implementations, the conveyance architecture involves linearly progressing towers along the conveyance path from grow room entry to grow room exit such that towers exit the grow room when they are ready for harvest. This linear, “single pass” movement of towers over the course of a relatively short (e.g., two week) plant life cycle enables tower indexing as plants age via a grow conveyance that spaces towers farther apart as it propels them forward.

Fruiting crops have longer life cycles (over eight weeks) than leafy greens. For fruiting crops numerous harvest events and other localized processing activities require tower movement throughout the life of the crop. This leads to a “loop” style conveyance architecture in which towers periodically travel along a loop path from the grow area to a processing area and back many times throughout the life of the crop. This loop style architecture is incompatible with the linear/single pass tower indexing approach used with leafy greens since towers traverse the same path when crops are at very different ages.

### Tower Indexing via Interleaving

According to embodiments of the disclosure, towers are “interleaved” to enable a discrete indexing step in a manner that is compatible with a fruiting crop loop-style conveyance architecture.

According to embodiments of the disclosure, the interleaving towers to enable a discrete indexing step may employ two types of load bars: tower load bars and conveyance load bars. Each tower load bar carries a group of towers spaced at “1X” density. Conveyance load bars are connected to the conveyance trolleys/running gear and are propelled by the conveyance system. As an example, conveyance load bars can carry one tower load bar (resulting in 1X density of plants on the conveyance load bar), or two tower load bars that are arranged with the towers “interleaved” with one another such that towers are spaced at “2X” density alternating between towers from one tower load bar and towers from the other.

Embodiments of the disclosure provide a system for transforming a first set of first plant support structures (e.g., grow towers) and a second set of second plant support structures from a high density arrangement to a low density arrangement, and vice versa. Each first plant support structure includes a plurality of first plant sites, and each second plant support structure including a plurality of second plant sites. The system includes at least one actuator (e.g., a robot or a forklift or similar mechanism) for deinterleaving the first and second sets to thereby move from the high density arrangement, in which the first and second sets are interleaved such that at least one second plant support structure is interposed between two first plant support structures, to the low density arrangement, in which the first and second sets are not interleaved. The actuator may also operate in reverse to interleave sets of plant support structures. The first and second sets may reside in a controlled agricultural environment.

The system may include a first attachment member (e.g., tower load bar) for holding together the first plant support structures of the first set, and a second attachment member for holding together the second plant support structures of the second set. The first attachment member may comprise a first support load bar (e.g., tower load bar), and the second attachment member may comprise a second support load bar.

Each first plant support structure may include at least one first complementary attachment member (e.g., a hook) to attach to the first attachment member, and each second plant support structure may include at least one second complementary attachment member to attach to the second attachment member.

The system may include at least one conveyance member (e.g., conveyance load bar) that attaches to the first and second attachment members. The conveyance load bar may be coupled to at least one trolley. The conveyance member may engage with and move along a conveyance line. According to embodiments of the disclosure, the at least one conveyance member comprises hangers. According to embodiments of the disclosure, each attachment member comprises at least one hanger window for engaging with one or more of the hangers. According to embodiments of the disclosure, the second attachment member comprises the same form as the first attachment member. According to embodiments of the disclosure, in the high density arrangement, the first and second attachment members are arranged in reverse orientations from each other on opposing sides of the at least one conveyance member.

The at least one actuator may be operably coupled to the first and second attachment members to perform the deinterleaving operation. The at least one actuator may move the deinterleaved second set to a position behind or in front of the first deinterleaved set with respect to a direction of conveyance. The at least one actuator may couple the moved, deinterleaved second set to engage with another conveyance member.

### BRIEF DESCRIPTION OF THE DRAWINGS

FIG. 1 is a functional block diagram illustrating an example of a controlled environment agriculture system.

FIG. 2 is a perspective view of an example of a controlled environment agriculture system.

FIGS. 3A and 3B are perspective views of an example grow tower.

FIG. 4A is a top view of an example grow tower; FIG. 4B is a perspective, top view of an example grow tower; FIG. 4C is an elevation view of a section of an example grow tower; and FIG. 4D is a sectional, elevation view of a portion of an example grow tower.

FIG. 5A is a perspective view of a portion of an example grow line.

FIG. 5B is a perspective view of an example tower hook.

FIG. 6 is an exploded, perspective view of a portion of an example grow line and reciprocating cam mechanism.

FIG. 7A is a sequence diagram illustrating operation of an example reciprocating cam mechanism.

FIG. 7B illustrates an alternative cam channel including an expansion joint.

FIG. 8 is a profile view of an example grow line and irrigation supply line.

FIG. 9 is a side view of an example tower hook and integrated funnel structure.

FIG. 10 is a profile view of an example grow line.

FIG. 11A is perspective view of an example tower hook and integrated funnel structure;

FIG. 11B is a section view of an example tower hook and integrated funnel structure; and

FIG. 11C is a top view of an example tower hook and integrated funnel structure.

FIG. 12 is an elevation view of an example carriage assembly.

FIG. 13 is a functional block diagram illustrating an irrigation loop according to embodiments of the disclosure.

FIG. 14A illustrates an example gutter according to embodiments of the disclosure;

FIG. 14B is a side elevation view of a collector end structure of the gutter; FIG. 14C is a perspective view of the collector end structure; FIG. 14D is a perspective view of a gutter section; and FIG. 14E is a side elevation view of the gutter section.

FIG. 15A is a perspective view of an example irrigation skid; and FIG. 15B is a side elevation view of the irrigation skid.

FIG. 16A is a sectional view of an irrigation line including a nozzle; FIG. 16B is a perspective view of an irrigation line and nozzle; FIG. 16C is a sectional view of a nozzle disposed within an aperture of the irrigation line; and FIG. 16D is a side view of an alternative nozzle.

FIG. 17A is a sectional view of an irrigation line including a nozzle with an air-bleed element; FIG. 17B is a perspective view of an irrigation line and nozzle with an air-bleed element; and FIG. 17C is a sectional view of a nozzle with an air-bleed element disposed within an aperture of the irrigation line.

FIG. 18 is a schematic diagram of an irrigation line according to embodiments of the disclosure.

FIG. 19 illustrates a grow space and an environmental conditioning system for conditioning air and fluid in the grow space, according to embodiments of the disclosure.

FIG. 20 illustrates an example of a computer system that may be used to execute instructions stored in a non-transitory computer readable medium (e.g., memory) in accordance with embodiments of the disclosure.

FIG. 21 illustrates an enhanced HVAC system including an economizer subsystem and an air conditioning subsystem, according to embodiments of the disclosure.

FIG. 22 illustrates a top view of the lighting assembly for a number of grow lines of receptacle supports (e.g., towers), according to embodiments of the disclosure.

FIG. 23 illustrates an irrigation subsystem according to embodiments of the disclosure.

FIGS. 24A-24D illustrate vertical indexing of plant support structures having nested segments, according to embodiments of the disclosure.

FIGS. 25A-25C illustrate vertical indexing of plant support structures employing a scissor mechanism, according to embodiments of the disclosure.

FIGS. 26A-26E illustrate vertical indexing of plant support structures employing a cable hoist mechanism, according to embodiments of the disclosure.

FIGS. 27A-27C illustrate approaches to an approach for rotationally controlling spacing of plants in a plant support structure, according to embodiments of the disclosure.

FIG. 28 illustrates a segment including a plant growth module and a removable plant capsule, according to embodiments of the disclosure.

FIGS. 29A-29B illustrate embodiments for rotationally controlling spacing of plants in a plant support structure, according to embodiments of the disclosure.

FIGS. 30A-30B illustrate vertical indexing of plant support structures using a screw mechanism, according to embodiments of the disclosure.

FIGS. 31A-31B illustrate a structure for adjusting spacing between tower segments, according to embodiments of the disclosure.

FIGS. 32A-32C illustrate a structure for adjusting spacing between tower segments, according to embodiments of the disclosure; FIGS. 32D-32E depict top views of a segment including its projection respectively disengaged and engaged with a hold, according to embodiments of the disclosure; FIG. 32F depicts a side view of a hold and a projection, according to embodiments of the disclosure.

FIGS. 33A and 33B depict a localized irrigation system, according to embodiments of the disclosure.

FIGS. 34A and 34B depict approaches to localized irrigation, according to embodiments of the disclosure.

FIGS. 35A and 35B are, respectively, isometric and side sectional views of an embodiment of a tower body segment and a plant capsule that fits into the segment.

FIGS. 35C and 35D are, respectively, side and side section views of segments stacked together to form towers, with capsules inserted into the segments, according to embodiments of the disclosure.

FIGS. 35E and 35F are, respectively, isometric and isometric section views of two segments stacked together, according to embodiments of the disclosure.

FIGS. 35G and 35H are, respectively, isometric and side views of a capsule, according to embodiments of the disclosure.

FIG. 35I (without fluid) and 35J (with flowing fluid) depict fluid supply and drainage channels and fluid flow in stacked segments of other embodiments of the disclosure.

FIGS. 36A-36C depict an irrigation assembly for irrigating individual plant sites of a group of towers simultaneously, according to embodiments of the disclosure.

FIG. 36D is an isometric view of an irrigation assembly, according to other embodiments of the disclosure.

FIGS. 36E-36G are top views of an irrigation assembly irrigating double sided towers, according to embodiments of the disclosure.

FIGS. 37A and 37B are top views of example tower conveyance mechanisms, according to embodiments of the disclosure.

FIGS. 38A-38D depict the conveyance of plant support structures (e.g., towers) along a conveyance line, according to embodiments of the disclosure.

FIG. 39 illustrates two sets of plant support structures, e.g., a first set of grow towers (light shading) and a second set of towers (dark shading), interleaved in a high density arrangement, according to embodiments of the disclosure.

FIGS. 40A-40D depict tower indexing from a high density arrangement to a low density arrangement to provide more space for the plants residing at tower plant sites as the plants grow.

FIGS. 41A-41B depict de-interleaving of towers as they move along a conveyance line during a grow cycle.

FIG. 42A illustrates details of a conveyance load bar and a tower load bar, according to embodiments of the disclosure.

FIG. 42B illustrates an alternative conveyance cradle having alternating sets of hooks that face in opposite directions, according to embodiments of the disclosure.

FIG. 43A depicts tower load bars with respective sets of tabs, according to embodiments of the disclosure.

FIG. 43B illustrates a first tower load bar having tabs for suspending towers, and a second tower load bar having tabs for suspending towers, according to embodiments of the disclosure.

FIG. 44A illustrates a side cross sectional view of a two-sided arrangement of towers, according to embodiments of the disclosure.

FIGS. 44B and 44C are perspective and side views, respectively, in which interleaved tower load bars and hang from a conveyance cradle.

FIG. 45 corresponds to FIG. 40D using alternative embodiments of conveyance cradles and tower load bars, and shows deinterleaved tower load bars hanging from conveyance cradles.

### DETAILED DESCRIPTION OF EMBODIMENTS OF THE DISCLOSURE

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Various modifications to the exemplary embodiments will be readily apparent to those skilled in the art, and the generic principles defined herein may be applied to other embodiments and applications without departing from the spirit and scope of the disclosure. Thus, this disclosure is not intended to be limited to the disclosed embodiments, but is to be accorded the widest scope consistent with the claims and the principles and features disclosed herein.

### Exemplary Indoor Agricultural System

The following describes a vertical farm production system configured for high density growth and crop yield. Although embodiments of the disclosure will primarily be described in the context of a vertical farm in which plants are grown in towers, those skilled in the art will recognize that the principles described herein are not limited to a vertical farm or the use of grow towers, but rather apply to plants grown in any structural arrangement.

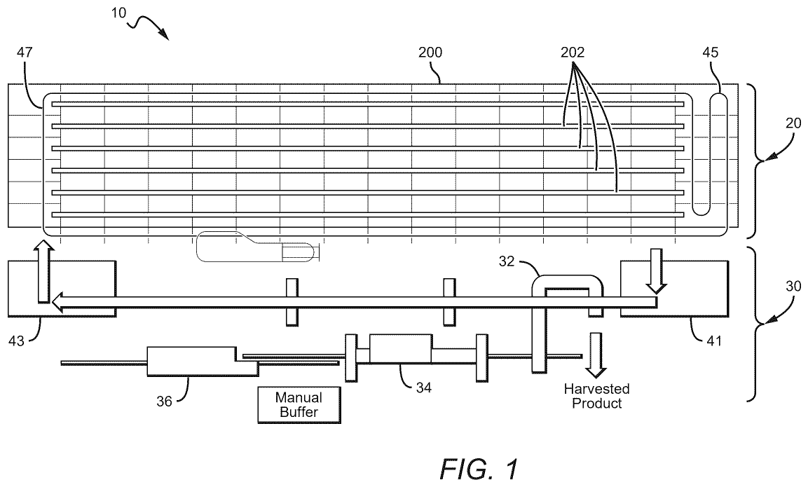

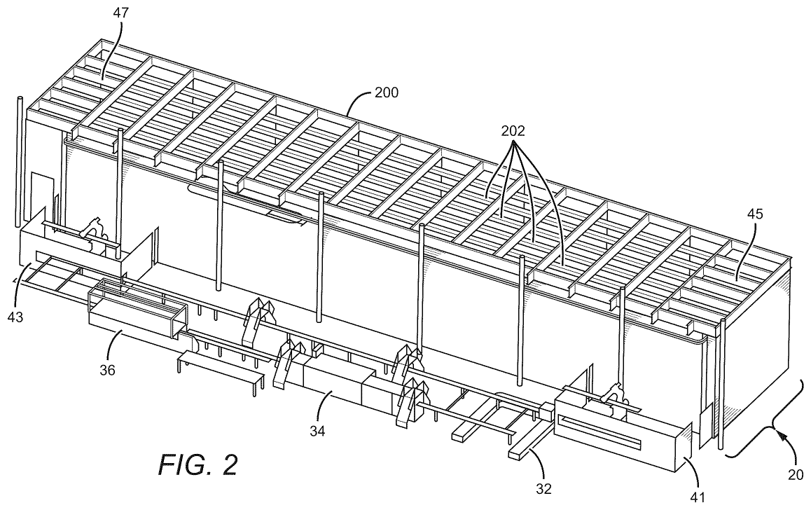

FIGS. 1 and 2 illustrate a controlled environment agriculture system 10, according to embodiments of the disclosure. At a high level, the system 10 may include an environmentally-controlled growing chamber 20, a vertical tower conveyance system 200 that is disposed within the growing chamber 20 and configured to convey vertical grow towers with crops disposed therein, and a central processing facility 30. The plant varieties that may be grown may be gravitropic/geotropic, phototropic, hydroponic, or some combination thereof. The varieties may vary considerably and include various leaf vegetables, fruiting vegetables, flowering crops, fruits, and the like. The controlled environment agriculture system 10 may be configured to grow a single crop type at a time or to grow multiple crop types concurrently.

The system 10 may also include conveyance systems for moving the grow towers in a circuit throughout the crop's growth cycle, the circuit comprising a staging area configured to load the grow towers into and out of the vertical tower conveyance mechanism 200. The central processing system 30 may include one or more conveyance mechanisms for directing grow towers to stations in the central processing system 30, e.g., stations for loading plant plugs into, and harvesting crops from, the grow towers. The vertical tower conveyance system 200 is configured to support and translate one or more grow towers 50 along grow lines 202. According to embodiments of the disclosure, the grow towers 50 hang from the grow lines 202.

Each grow tower 50 is configured to contain plant growth media that supports a root structure of at least one crop plant growing therein. Each grow tower 50 is also configured to releasably attach to a grow line 202 in a vertical orientation and move along the grow line 202 during a growth phase. Together, the vertical tower conveyance mechanism 200 and the central processing system 30 (including associated conveyance mechanisms) can be arranged in a production circuit under control of one or more computing systems.

The growth environment 20 may include light emitting sources positioned at various locations between and along the grow lines 202 of the vertical tower conveyance system 200. The light emitting sources can be positioned laterally relative to the grow towers 50 in the grow line 202 and configured to emit light toward the lateral faces of the grow towers 50, which include openings from which crops grow. The light emitting sources may be incorporated into a water-cooled, LED lighting system as described in U.S. Publication No. 2017/0146226A1, the disclosure of which is incorporated by reference in its entirety herein. In such an embodiment, the LED lights may be arranged in a bar-like structure. The bar-like structure may be placed in a vertical orientation to emit light laterally to substantially the entire length of adjacent grow towers 50. Multiple light bar structures may be arranged in the growth environment 20 along and between the grow lines 202. Other lighting systems and configurations may be employed. For example, the light bars may be arranged horizontally between grow lines 202.

The growth environment 20 may also include a nutrient supply system configured to supply an aqueous crop nutrient solution to the crops as they translate through the growth chamber 20. The nutrient supply system may apply aqueous crop nutrient solution to the top of the grow towers 50. Gravity may cause the solution travel down the vertically-oriented grow tower 50 and through the length thereof to supply solution to the crops disposed along the length of the grow tower 50. The growth environment 20 may also include an airflow source that is configured to, when a tower is mounted to a grow line 202, direct airflow in the lateral growth direction of growth and through an under-canopy of the growing plant, so as to disturb the boundary layer of the under-canopy of the growing plant. In other implementations, airflow may come from the top of the canopy or orthogonal to the direction of plant growth. The growth environment 20 may also include a control system, and associated sensors, for regulating at least one growing condition, such as air temperature, airflow speed, relative air humidity, and ambient carbon dioxide gas content. The control system may for example include such sub-systems as HVAC units, chillers, fans and associated ducting and air handling equipment. Grow towers 50 may have identifying attributes (such as bar codes or RFID tags). The controlled environment agriculture system 10 may include corresponding sensors and programming logic for tracking the grow towers 50 during various stages of the farm production cycle or for controlling one or more conditions of the growth environment. The operation of control system and the length of time towers remain in the growth environment can vary considerably depending on a variety of factors, such as crop type and other factors.

The grow towers 50 with newly transplanted crops or seedlings are transferred from the central processing system 30 into the vertical tower conveyance system 200. Vertical tower conveyance system 200 moves the grow towers 50 along respective grow lines 202 in growth environment 20 in a controlled fashion. Crops disposed in grow towers 50 are exposed to the controlled conditions of the growth environment (e.g., light, temperature, humidity, air flow, aqueous nutrient supply, etc.). The control system is capable of automated adjustments to optimize growing conditions within the growth chamber 20 and make continuous improvements to various attributes, such as crop yields, visual appeal and nutrient content. In addition, US Patent Publication Nos. 2018/0014485 and 2018/0014486, incorporated by reference herein, describe application of machine learning and other operations to optimize grow conditions in a vertical farming system. In some implementations, environmental condition sensors may be disposed on grow towers 50 or at various locations in the growth environment 20. When crops are ready for harvesting, grow towers 50 with crops to be harvested are transferred from the vertical tower conveyance system 200 to the central processing system 30 for harvesting and other processing operations.

Central processing system 30 may include processing stations directed to injecting seedlings into towers 50, harvesting crops from towers 50, and cleaning towers 50 that have been harvested. Central processing system 30 may also include conveyance mechanisms that move towers 50 between such processing stations. For example, as FIG. 1 illustrates, central processing system 30 may include harvester station 32, washing station 34, and transplanter station 36. Harvester station 32 may deposit harvested crops into food-safe containers and may include a conveyance mechanism for conveying the containers to post-harvesting facilities (e.g., preparation, washing, packaging and storage).

Controlled environment agriculture system 10 may also include one or more conveyance mechanisms for transferring grow towers 50 between growth environment 20 and central processing system 30. In the implementation shown, the stations of central processing system 30 operate on grow towers 50 in a horizontal orientation. In one implementation, an automated pickup (loading) station 43, and associated control logic, may be operative to releasably grasp a horizontal tower from a loading location, rotate the tower to a vertical orientation and attach the tower to a transfer station for insertion into a selected grow line 202 of the growth environment 20. On the other end of growth environment 20, automated laydown (unloading) station 41, and associated control logic, may be operative to releasably grasp and move a vertically oriented grow tower 50 from a buffer location, rotate the grow tower 50 to a horizontal orientation and place it on a conveyance system for loading into harvester station 32. In some implementations, if a grow tower 50 is rejected due to quality control concerns, the conveyance system may bypass the harvester station 32 and carry the grow tower to washing station 34 (or some other station). The automated laydown and pickup stations 41 and 43 may each comprise a six-degrees of freedom robotic arm, such as a FANUC robot. The stations 41 and 43 may also include end effectors for releasably grasping grow towers 50 at opposing ends.

Growth environment 20 may also include automated loading and unloading mechanisms for inserting grow towers 50 into selected grow lines 202 and unloading grow towers 50 from the grow lines 202. According to embodiments of the disclosure, a load transfer conveyance mechanism 47 may include a powered and free conveyor system that conveys carriages each loaded with a grow tower 50 from the automated pickup station 43 to a selected grow line 202. Vertical grow tower conveyance system 200 may include sensors (such as RFID or bar code sensors) to identify a given grow tower 50 and, under control logic, select a grow line 202 for the grow tower 50. The load transfer conveyance mechanism 47 may also include one or more linear actuators that pushes the grow tower 50 onto a grow line 202. Similarly, the unload transfer conveyance mechanism 45 may include one or more linear actuators that push or pull grow towers from a grow line 202 onto a carriage of another powered and free conveyor mechanism, which conveys the carriages 1202 from the grow line 202 to the automated laydown station 41.

FIG. 12 illustrates a carriage 1202 that may be used in a powered and free conveyor mechanism. In the implementation shown, carriage 1202 includes hook 1204 that engages hook 52 of grow tower 50. A latch assembly 1206 may secure the grow tower 50 while it is being conveyed to and from locations in the system. In one implementation, one or both of load transfer conveyance mechanism 47 and unload transfer conveyance mechanism 45 may be configured with a sufficient track distance to establish a zone where grow towers 50 may be buffered. For example, unload transfer conveyance mechanism 45 may be controlled such that it unloads a set of towers 50 to be harvested unto carriages 1202 that are moved to a buffer region of the track. On the other end, automated pickup station 43 may load a set of towers to be inserted into growth environment 20 onto carriages 1202 disposed in a buffer region of the track associated with load transfer conveyance mechanism 47.

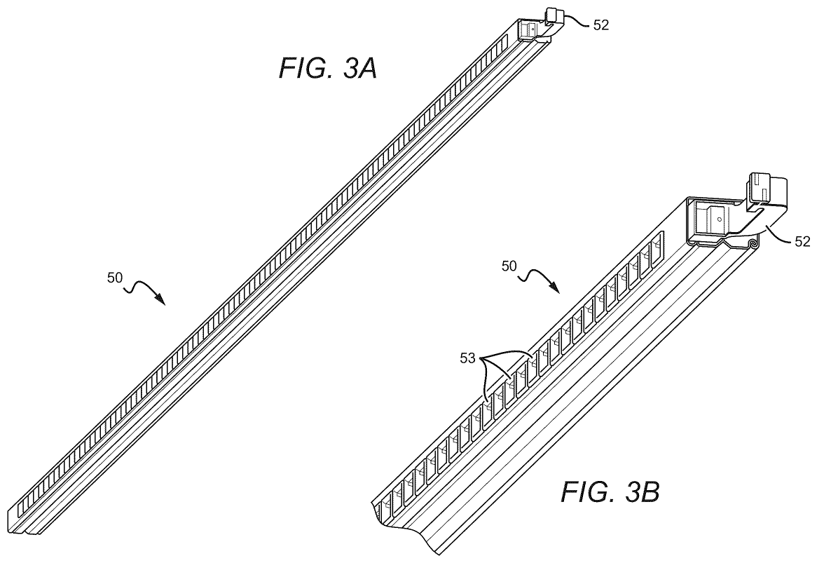

Grow Towers Grow towers 50 provide the sites for individual crops to grow in the system. As FIGS. 3A and 3B illustrate, a tower 50 includes a hook 52 at the top. Hook 52 allows grow tower 50 to be supported by a grow line 202 when it is inserted into the vertical tower conveyance system 200. In one implementation, a grow tower 50 measures 5.172 meters long, where the extruded length of the tower is 5.0 meters, and the hook is 0.172 meters long. The extruded rectangular profile of the grow tower 50, in one implementation, measures 57 mm×93 mm (2.25″×3.67″). The hook 52 can be designed such that its exterior overall dimensions are not greater than the extruded profile of the grow tower 50. The dimensions of grow tower 50 can be varied depending on a number of factors, such as desired throughput, overall size of the system, and the like.

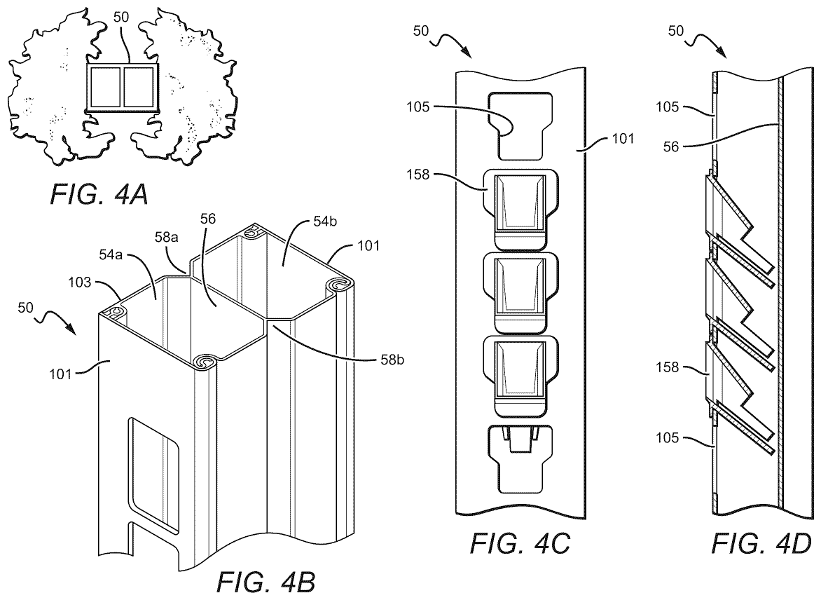

Grow towers 50 may include a set of grow sites 53 arrayed along at least one face of the grow tower 50. In the implementation shown in FIG. 4A, grow towers 50 include grow sites 53 on opposing faces such that plants protrude from opposing sides of the grow tower 50.

Transplanter station 36 may transplant seedlings into empty grow sites 53 of grow towers 50, where they remain in place until they are fully mature and ready to be harvested. In one implementation, the orientation of the grow sites 53 are perpendicular to the direction of travel of the grow towers 50 along grow line 202. In other words, when a grow tower 50 is inserted into a grow line 202, plants extend from opposing faces of the grow tower 50, where the opposing faces are parallel to the direction of travel. Although a dual-sided configuration is preferred, the invention may also be utilized in a single-sided configuration where plants grow along a single face of a grow tower 50.

U.S. application Ser. No. 15/968,425 filed on May 1, 2018, which is incorporated by reference herein for all purposes, discloses an example tower structure configuration that can be used in connection with various embodiments of the disclosure. In the implementation shown, grow towers 50 may each comprise three extrusions which snap together to form one structure. As shown, the grow tower 50 may be a dual-sided hydroponic tower, where the tower body 103 includes a central wall 56 that defines a first tower cavity 54a and a second tower cavity 54b. FIG. 4B provides a perspective view of an exemplary dual-sided, multi-piece hydroponic grow tower 50 in which each front face plate 101 is hingeably coupled to the tower body 103. In FIG. 4B, each front face plate 101 is in the closed position. The cross-section of the tower cavities 54a, 54b may be in the range of 1.5 inches by 1.5 inches to 3 inches by 3 inches, where the term “tower cavity” refers to the region within the body of the tower and behind the tower face plate. The wall thickness of the grow towers 50 maybe within the range of 0.065 to 0.075 inches. A dual-sided hydroponic tower, such as that shown in FIGS. 4A and 4B, has two back-to-back cavities 54a and 54b, each preferably within the noted size range. In the configuration shown, the grow tower 50 may include (i) a first V-shaped groove 58a running along the length of a first side of the tower body 103, where the first V-shaped groove is centered between the first tower cavity and the second tower cavity; and (ii) a second V-shaped groove 58b running along the length of a second side of the tower body 103, where the second V-shaped groove is centered between the first tower cavity and the second tower cavity. The V-shaped grooves 58a, 58b may facilitate registration, alignment and/or feeding of the towers 50 by one or more of the stations in central processing system 30.

U.S. application Ser. No. 15/968,425 discloses additional details regarding the construction and use of towers that may be used in embodiments of the disclosure. Another attribute of V-shaped grooves 58a, 58b is that they effectively narrow the central wall 56 to promote the flow of aqueous nutrient solution centrally where the plant's roots are located. Other implementations are possible. For example, a grow tower 50 may be formed as a unitary, single extrusion, where the material at the side walls flex to provide a hinge and allow the cavities to be opened for cleaning.

As FIGS. 4C and 4D illustrate that grow towers 50 may each include a plurality of receptacles 105, for example cut-outs 105 as shown, that may be used with a compatible growth module 158, such as a plug holder. (The terms “plant holder” or “plant site” herein may refer to a receptacle 105 or a plug holder/growth module 158, for example.) Each plug holder holds a plant of a given variety. Plug holder 158 may be ultrasonically welded, bonded, or otherwise attached to tower face 101. As shown, the growth modules 158 may be oriented at a 45-degree angle relative to the front face plate 101 and the vertical axis of the grow tower 50. It should be understood, however, that tower design disclosed in the present application is not limited to use with a particular plug holder or orientation, rather, the towers disclosed herein may be used with any suitably sized or oriented growth module. As such, cut-outs 105 are only meant to illustrate, not limit, the present tower design and it should be understood that embodiments may employ towers with other receptacle designs. In particular, receptacle supports other than towers may be used to support plants. In general, the receptacles may be part of any receptacle support structure for supporting plants within the grow space. For example, the receptacles may be laid out in rows and columns in a horizontal plane. The receptacle support may comprise a member (e.g., a tray, a table, an arm) holding multiple receptacles in a longitudinal (e.g., row) direction. The receptacles may be conveyed during their growth cycle in the longitudinal direction.

The use of a hinged front face plate simplifies manufacturing of grow towers, as well as tower maintenance in general and tower cleaning in particular. For example, to clean a grow tower 50 the face plates 101 are opened from the body 103 to allow easy access to the body cavity 54a or 54b. After cleaning, the face plates 101 are closed. Since the face plates remain attached to the tower body 103 throughout the cleaning process, it is easier to maintain part alignment and to insure that each face plate is properly associated with the appropriate tower body and, assuming a double-sided tower body, that each face plate 101 is properly associated with the appropriate side of a specific tower body 103. Additionally, if the planting and/or harvesting operations are performed with the face plate 101 in the open position, for the dual-sided configuration both face plates can be opened and simultaneously planted and/or harvested, thus eliminating the step of planting and/or harvesting one side and then rotating the tower and planting and/or harvesting the other side. In other embodiments, planting and/or harvesting operations are performed with the face plate 101 in the closed position.

Other implementations are possible. For example, grow tower 50 can comprise any tower body that includes a volume of medium or wicking medium extending into the tower interior from the face of the tower (either a portion or individual portions of the tower or the entirety of the tower length. For example, U.S. Pat. No. 8,327,582, which is incorporated by reference herein, discloses a grow tube having a slot extending from a face of the tube and a grow medium contained in the tube. The tube illustrated therein may be modified to include a hook 52 at the top thereof and to have slots on opposing faces, or one slot on a single face.

### Vertical Tower Conveyance System

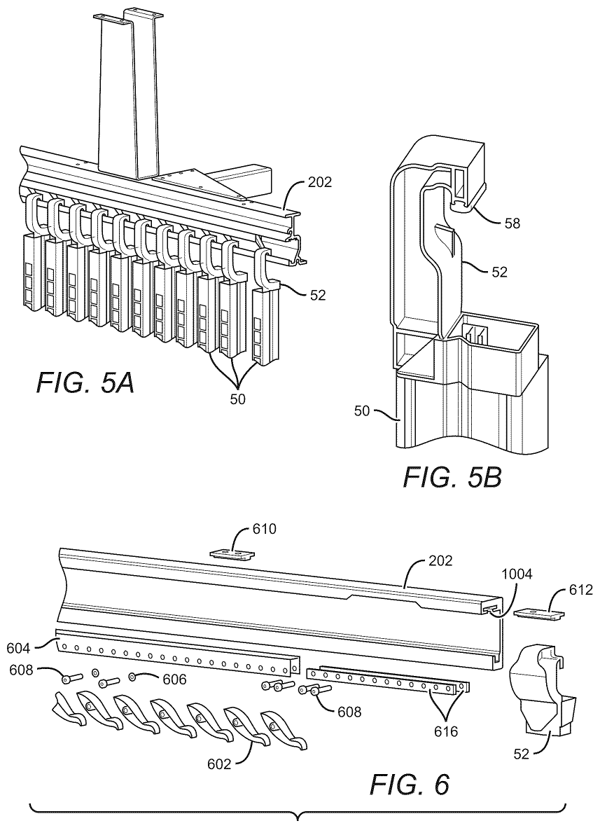

FIG. 5A illustrates a portion of a grow line 202 in the vertical tower conveyance system 200. According to embodiments of the disclosure, the vertical tower conveyance system 200 includes grow lines 202 arranged in parallel. As discussed elsewhere herein, automated loading and unloading mechanisms 45, 47 may selectively load and unload grow towers 50 from a grow line 202 under automated control systems. As shown, each grow line 202 supports a plurality of grow towers 50. In one implementation, a grow line 202 may be mounted to the ceiling (or other support) of the grow structure by a bracket for support purposes. Hook 52 hooks into, and attaches, a grow tower 50 to a grow line 202, thereby supporting the tower in a vertical orientation as it is translated through the vertical tower conveyance system 200. A conveyance mechanism moves towers 50 attached to respective grow lines 202.

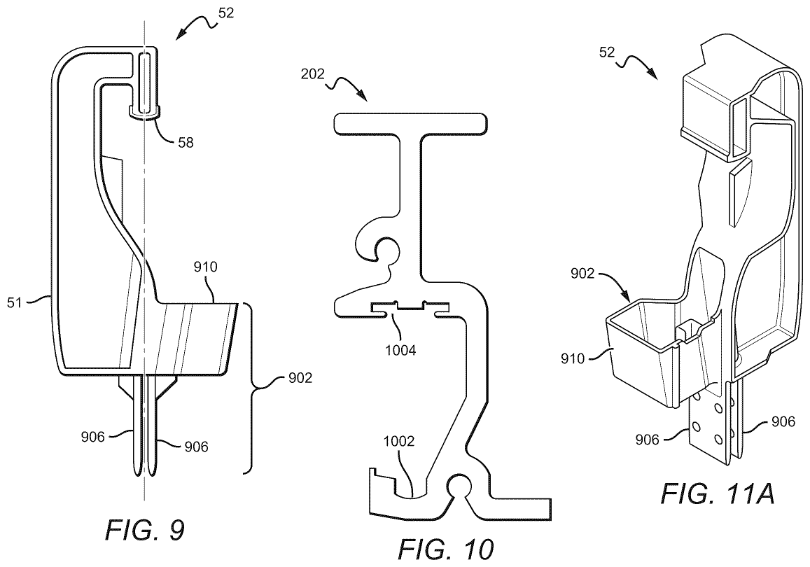

FIG. 10 illustrates the cross section or extrusion profile of a grow line 202, according to embodiments of the disclosure. The grow line 202 may be an aluminum extrusion. The bottom section of the extrusion profile of the grow line 202 includes an upward facing groove 1002. As FIG. 9 shows, hook 52 of a grow tower 50 includes a main body 51 and corresponding member 58 that engages groove 1002 as shown in FIGS. 5A and 8. These hooks allow the grow towers 50 to hook into the groove 1002 and index along the grow line 202 as discussed below. Conversely, grow towers 50 can be manually unhooked from a grow line 202 and removed from production. This ability may be necessary if a crop in a grow tower 50 becomes diseased so that it does not infect other towers. In one implementation, the width of groove 1002 (for example, 13 mm) is an optimization between two different factors. First, the narrower the groove the more favorable the binding rate and the less likely grow tower hooks 52 are to bind. Conversely, the wider the groove the slower the grow tower hooks wear due to having a greater contact patch. Similarly, the depth of the groove, for example 10 mm, may be an optimization between space savings and accidental fallout of tower hooks.

Hooks 52 may be injection-molded plastic parts. In one implementation, the plastic may be polyvinyl chloride (PVC), acrylonitrile butadiene styrene (ABS), or an Acetyl Homopolymer (e.g., Delrin® sold by DuPont Company). The hook 52 may be solvent bonded to the top of the grow tower 50 and/or attached using rivets or other mechanical fasteners. The groove-engaging member 58 which rides in the rectangular groove 1002 of the grow line 202 may be a separate part or integrally formed with hook 52. If separate, this part can be made from a different material with lower friction and better wear properties than the rest of the hook, such as ultra-high-molecular weight polyethylene or acetal. To keep assembly costs low, this separate part may snap onto the main body of the hook 52.

Alternatively, the separate part also be over-molded onto the main body of hook 52.

As FIGS. 6 and 10 illustrate, the top section of the extrusion profile of grow line 202 contains a downward facing t-slot 1004. Linear guide carriages 610 (described below) ride within the t-slot 1004. The center portion of the t-slot 1004 may be recessed to provide clearance from screws or over-molded inserts which may protrude from the carriages 610.

Each grow line 202 can be assembled from a number of separately fabricated sections. In one implementation, sections of grow line 202 are currently modeled in 5 to 6-meter lengths. Longer sections reduce the number of junctions but are more susceptible to thermal expansion issues and may significantly increase shipping costs. Additional features not captured by the figures include intermittent mounting holes to attach the grow line 202 to the ceiling structure and to attach irrigation lines. Interruptions to the t-slot 1004 may also be machined into the conveyor body. These interruptions allow the linear guide carriages 610 to be removed without having to slide them all the way out the end of a grow line 202.

At the junction between two sections of a grow line 202, a block 612 may be located in the t-slots 1004 of both conveyor bodies. This block serves to align the two grow line sections so that grow towers 50 may slide smoothly between them. Alternative methods for aligning sections of a grow line 202 include the use of dowel pins that fit into dowel holes in the extrusion profile of the section. The block 612 may be clamped to one of the grow line sections via a set screw, so that the grow line sections can still come together and move apart as the result of thermal expansion. Based on the relatively tight tolerances and small amount of material required, these blocks may be machined. Bronze may be used as the material for such blocks due to its strength, corrosion resistance, and wear properties.

In one implementation, the vertical tower conveyance system 200 utilizes a reciprocating linear ratchet and pawl structure (hereinafter referred to as a “reciprocating cam structure or mechanism”) to move grow towers 50 along a grow line 202. FIGS. 5A, 6 and 7 illustrate one possible reciprocating cam mechanism that can be used to move grow towers 50 across grow lines 202. Pawls or “cams” 602 physically push grow towers 50 along grow line 202. Cams 602 are attached to cam channel 604 (see below) and rotate about one axis. On the forward stroke, the rotation is limited by the top of the cam channel 604, causing the cams 602 to push grow towers 50 forward. On the reserve or back stroke, the rotation is unconstrained, thereby allowing the cams to ratchet over the top of the grow towers 50. In this way, the cam mechanism can stroke a relatively short distance back and forth, yet grow towers 50 always progress forward along the entire length of a grow line 202. A control system, in one implementation, controls the operation of the reciprocating cam mechanism of each grow line 202 to move the grow towers 50 according to a programmed growing sequence. In between movement cycles, the actuator and reciprocating cam mechanism remain idle.

The pivot point of the cams 602 and the means of attachment to the cam channel 604 consists of a binding post 606 and a hex head bolt 608; alternatively, detent clevis pins may be used. The hex head bolt 608 is positioned on the inner side of the cam channel 604 where there is no tool access in the axial direction. Being a hex head, it can be accessed radially with a wrench for removal. Given the large number of cams needed for a full-scale farm, a high-volume manufacturing process such as injection molding is suitable. ABS is suitable material given its stiffness and relatively low cost. All the cams 602 for a corresponding grow line 202 are attached to the cam channel 604. When connected to an actuator, this common beam structure allows all cams 602 to stroke back and forth in unison. The structure of the cam channel 604, in one implementation, is a downward facing u-channel constructed from sheet metal. Holes in the downward facing walls of cam channel 604 provide mounting points for cams 602 using binding posts 606.

Holes of the cam channel 604, in one implementation, are spaced at 12.7 mm intervals. Therefore, cams 602 can be spaced relative to one another at any integer multiple of 12.7 mm, allowing for variable grow tower spacing with only one cam channel. The base of the cam channel 604 limits rotation of the cams during the forward stroke. All degrees of freedom of the cam channel 604, except for translation in the axial direction, are constrained by linear guide carriages 610 (described below) which mount to the base of the cam channel 604 and ride in the t-slot 1004 of the grow line 202. Cam channel 604 may be assembled from separately formed sections, such as sections in 6-meter lengths. Longer sections reduce the number of junctions but may significantly increase shipping costs. Thermal expansion is generally not a concern because the cam channel is only fixed at the end connected to the actuator. Given the simple profile, thin wall thickness, and long length needed, sheet metal rolling is a suitable manufacturing process for the cam channel. Galvanized steel is a suitable material for this application.

Linear guide carriages 610 are bolted to the base of the cam channels 604 and ride within the t-slots 1004 of the grow lines 202. In some implementations, one carriage 610 is used per 6-meter section of cam channel. Carriages 610 may be injection molded plastic for low friction and wear resistance. Bolts attach the carriages 610 to the cam channel 604 by threading into over molded threaded inserts. If select cams 602 are removed, these bolts are accessible so that a section of cam channel 604 can be detached from the carriage and removed.

Sections of cam channel 604 are joined together with pairs of connectors 616 at each joint; alternatively, detent clevis pins may be used. Connectors 616 may be galvanized steel bars with machined holes at 20 mm spacing (the same hole spacing as the cam channel 604). Shoulder bolts 618 pass through holes in the outer connector, through the cam channel 604, and thread into holes in the inner connector. If the shoulder bolts fall in the same position as a cam 602, they can be used in place of a binding post. The heads of the shoulder bolts 618 are accessible so that connectors and sections of cam channel can be removed.

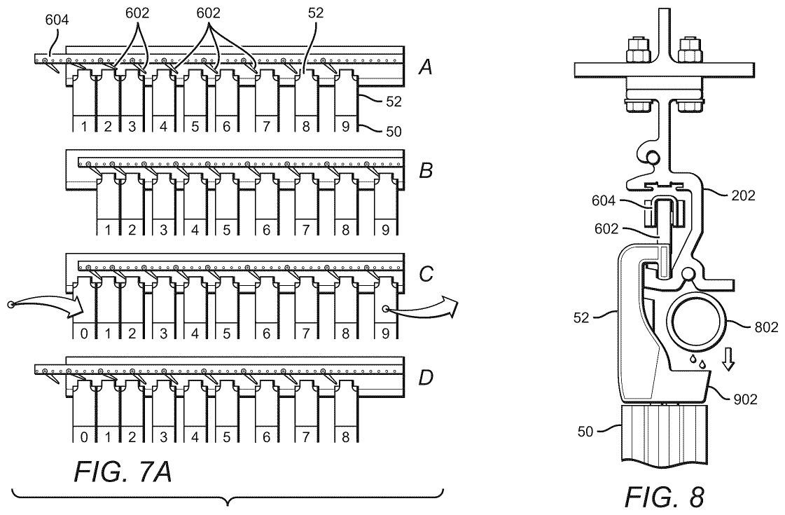

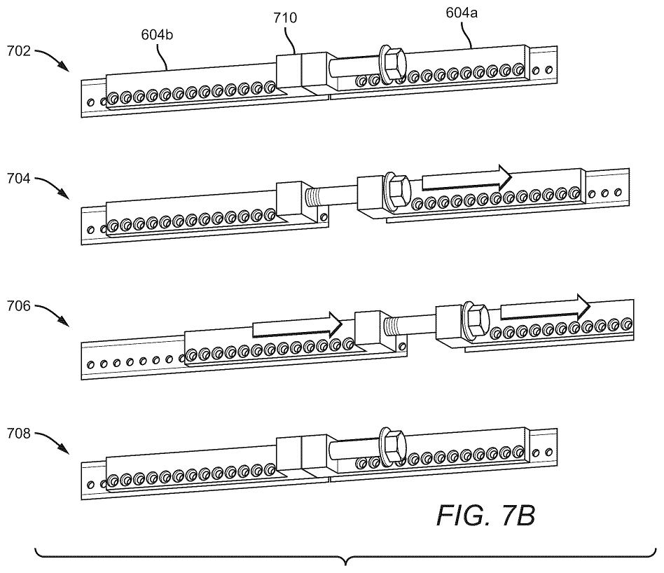

In one implementation, cam channel 604 attaches to a linear actuator, which operates in a forward and a back stroke. A suitable linear actuator may be the T13-B4010MS053-62 actuator offered by Thomson, Inc. of Redford, Virginia; however, the reciprocating cam mechanism described herein can be operated with a variety of different actuators. The linear actuator may be attached to cam channel 604 at the off-loading end of a grow line 202, rather than the on-boarding end. In such a configuration, cam channel 604 is under tension when loaded by the towers 50 during a forward stroke of the actuator (which pulls the cam channel 604) which reduces risks of buckling. FIG. 7A illustrates operation of the reciprocating cam mechanism according to embodiments of the disclosure. In step A, the linear actuator has completed a full back stroke; as FIG. 7A illustrates, one or more cams 602 may ratchet over the hooks 52 of a grow tower 50. Step B of FIG. 7A illustrates the position of cam channel 604 and cams 602 at the end of a forward stroke. During the forward stroke, cams 602 engage corresponding grow towers 50 and move them in the forward direction along grow line 202 as shown. Step C of FIG. 7A illustrates how a new grow tower 50 (Tower 0) may be inserted onto a grow line 202 and how the last tower (Tower 9) may be removed. Step D illustrates how cams 602 ratchet over the grow towers 50 during a back stroke, in the same manner as Step A. The basic principle of this reciprocating cam mechanism is that reciprocating motion from a relatively short stroke of the actuator transports towers 50 in one direction along the entire length of the grow line 202. More specifically, on the forward stroke, all grow towers 50 on a grow line 202 are pushed forward one position. On the back stroke, the cams 602 ratchet over an adjacent tower one position back; the grow towers remain in the same location. As shown, when a grow line 202 is full, a new grow tower may be loaded and a last tower unloaded after each forward stroke of the linear actuator. In some implementations, the top portion of the hook 52 (the portion on which the cams push), is slightly narrower than the width of a grow tower 50. As a result, cams 602 can still engage with the hooks 52 when grow towers 50 are spaced immediately adjacent to each other. FIG. 7A shows 9 grow towers for didactic purposes.

A grow line 202 can be configured to be quite long (for example, 40 meters) allowing for a much greater number of towers 50 on a grow line 202 (such as 400-450). Other implementations are possible. For example, the minimum tower spacing can be set equal to or slightly greater than two times the side-to-side distance of a grow tower 50 to allow more than one grow tower 50 to be loaded onto a grow line 202 in each cycle.

Still further, as shown in FIG. 7A, the spacing of cams 602 along the cam channel 604 can be arranged to effect one-dimensional plant indexing along the grow line 202. In other words, the cams 602 of the reciprocating cam mechanism can be configured such that spacing between towers 50 increases as they travel along a grow line 202. For example, spacing between cams 602 may gradually increase from a minimum spacing at the beginning of a grow line to a maximum spacing at the end of the grow line 202. This may be useful for spacing plants apart as they grow to increase light interception and provide spacing, and, through variable spacing or indexing, increasing efficient usage of the growth chamber 20 and associated components, such as lighting. In one implementation, the forward and back stroke distance of the linear actuator is equal to (or slightly greater than) the maximum tower spacing. During the back stroke of the linear actuator, cams 602 at the beginning of a grow line 202 may ratchet and overshoot a grow tower 50. On the forward stroke, such cams 602 may travel respective distances before engaging a tower, whereas cams located further along the grow line 202 may travel shorter distances before engaging a tower or engage substantially immediately. In such an arrangement, the maximum tower spacing cannot be two times greater than the minimum tower spacing; otherwise, a cam 602 may ratchet over and engaging two or more grow towers 50. If greater maximum tower spacing is desired, an expansion joint may be used, as illustrated in FIG. 7B. An expansion joint allows the leading section of the cam channel 604 to begin traveling before the trailing end of the cam channel 604, thereby achieving a long stroke. In particular, as FIG. 7B shows, expansion joint 710 may attach to sections 604a and 604b of cam channel 604. In the initial position (702), the expansion joint 710 is collapsed. At the beginning of a forward stroke (704), the leading section 604a of cam channel 604 moves forward (as the actuator pulls on cam channel 604), while the trailing section 604b remains stationary. Once the bolt bottoms out on the expansion joint 710 (706), the trailing section 604 of cam channel 604 begins to move forward as well. On the back stroke (708), the expansion joint 710 collapses to its initial position.

Other implementations for moving vertical grow towers 50 may be employed. For example, a lead screw mechanism may be employed. In such an implementation, the threads of the lead screw engage hooks 52 disposed on grow line 202 and move grow towers 50 as the shaft rotates. The pitch of the thread may be varied to achieve one-dimensional plant indexing. In another implementation, a belt conveyor include paddles along the belt may be employed to move grow towers 50 along a grow line 202. In such an implementation, a series of belt conveyors arranged along a grow line 202, where each belt conveyor includes a different spacing distance among the paddles to achieve one-dimensional plant indexing. In yet other implementations, a power-and-free conveyor may be employed to move grow towers 50 along a grow line 202.

Other configurations for grow line 202 are possible. For example, although the grow line 202 illustrated in the various figures is horizontal to the ground, the grow line 202 may be sloped at a slight angle, either downwardly or upwardly relative to the direction of tower travel. Still further, while the grow line 202 described above operates to convey grow towers in a single direction, the grow line 202 may be configured to include multiple sections, where each section is oriented in a different direction. For example, two sections may be perpendicular to each other. In other implementations, two sections may run parallel to each other, but have opposite directions of travel, to form a substantially u-shaped travel path. In such an implementation, a return mechanism can transfer grow towers from the end of the first path section to the onload end of the second path section of the grow line.

### Irrigation & Aqueous Nutrient Supply System

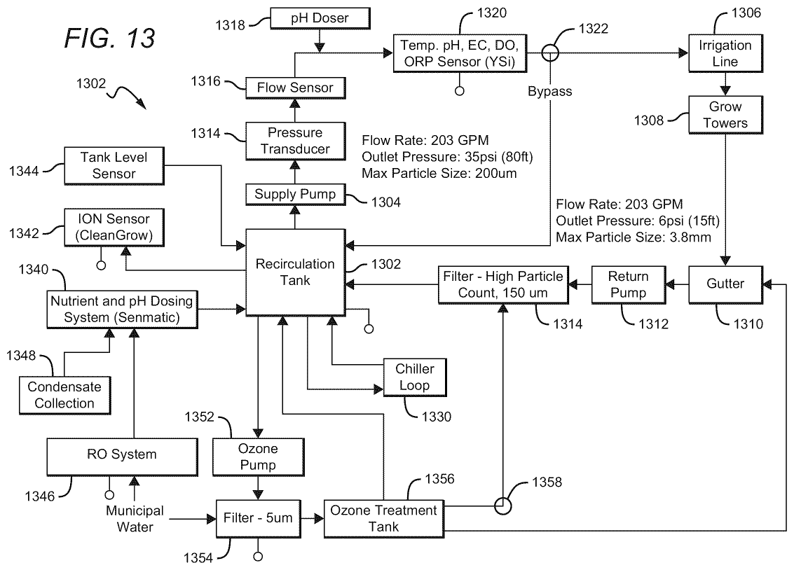

FIG. 13 is a functional block diagram setting forth the components of an irrigation system according to embodiments of the disclosure. In the implementation shown, the irrigation system 1300 is a closed-loop system comprising a recirculation tank 1302 that both supplies nutrient solution to grow towers 50 and receives excess or remaining nutrient solution returning from the grow towers 50. In the particular implementation shown, supply pump 1304 pumps aqueous nutrient solution from recirculation tank 1302 to one or more irrigation lines 1306 disposed above grow towers 1308. Gutter 1310 recovers excess aqueous nutrient solution that drops from grow towers 1308. A return pump 1312 returns excess aqueous nutrient solution to the screen filter, which then returns clean water to the recirculation tank 1302.

As FIG. 13 illustrates, irrigation system 1300 may include one or more components for conditioning or treating the aqueous nutrient solution, as well as sensing conditions at various points in the irrigation loop. For example, return filter 1314 may filter debris and other particulate matter prior to returning excess aqueous nutrient solution to the recirculation tank 1302. In one implementation, return filter may be a 150 micrometer, parabolic screen filter; however, other filters, such as media and disc filters, can be used depending on the particular application and expected particle size and quantity in excess aqueous nutrient solution. In some implementations, recirculation tank 1302 may include cooling cools. Chiller loop 1330 supplies cooling fluid through the coils to facilitate achieving a target temperature for the aqueous nutrient solution to be supplied to irrigation line 1306.

Crops in grow towers 50 will generally take up nutrients from aqueous nutrient solution, thereby lowering nutrient levels in the excess nutrient solution returning to recirculation tank 1302. Irrigation system 1300 may also include nutrient and pH dosing system 1340, ion sensor 1342 and tank level sensor 1344. During operation, ion sensor 1342 may sample the nutrient solution at a predefined interval. During sampling, ion sensor 1342 may check the ion levels of 8 separate nutrients and compare them to desired nutrient levels. Ion sensor 1342 may be an 8-ion analyzer offered by CleanGrow Sensors of Wolverhampton, United Kingdom. Responsive to detected nutrient levels, nutrient and pH dosing system 1350 may inject a single element type dose to be delivered to the recirculation tank 1302, based on the nutrient mix desired, and the room available in the tank (as sensed by tank level sensor 1344, for the water needed to transport the dose). In some implementations, nutrient and pH dosing system 1350 may use the sensed nutrient data and a desired nutrient recipe to calculate a nutrient adjustment mix to adjust the nutrient levels of recirculation tank 1302, using the smallest available volume in the tank. Nutrient and pH dosing system 1340 may include one or more venturi injectors for dosing particular nutrient solutions into the irrigation loop. In one implementation, nutrient and pH dosing system 1340 is an AMI Penta Fertilizer Mixer unit offered by Senmatic A/S of Sanderso, Denmark.

Irrigation system 1300 may also include pressure transducer 1314 and flow sensor 1316 to monitor irrigation loop conditions and control the operation of supply pump 1304.

According to embodiments of the disclosure, flow sensors 1316 may also be located in or near air supply ducts or nutrient water returns (e.g., gutters). Irrigation system 1300 may also use water from condensate collection mechanism 1348, in one implementation as a primary source of water for the nutrient water. Condensate collection mechanism 1348 recaptures condensate in the air contained within growth environment 20 using, in one implementation, mechanical dehumidification. Reverse osmosis system 1346 filters water received from an external water source, such as a municipal water system, to the extent irrigation system 1300 requires additional water. In some implementations, reverse osmosis system 1346 may also filter water received from condensate collection mechanism 1348. Irrigation system 1300 may also include components for ozone treatment and cleaning of aqueous nutrient solution. For example, ozone pump 1352 supplies aqueous nutrient solution to ozone treatment tank 1356 filtered by filter 1354. Bypass valve 1358 can be used to redirect ozone injected water to treat the screen filter.

Irrigation system 1300 may also include in-line pH dosing system 1318 and 5-in-1 sensor 1320. 5-in-1 sensor samples temperature, pH, Electrical Conductivity (EC), dissolved oxygen and oxidization reduction potential of aqueous nutrient solution. In-line pH dosing system 1318 can make micro-adjustments to pH levels based on sensed pH in the irrigation loop. The cooling loop 1380 may be controlled based on the temperature that is read by 5-1 sensor 1320. Irrigation system 1300 may also include bypass valve 1322 to allow the irrigation supply, sensing components, and/or the filter to run without aqueous nutrient solution reaching irrigation line 1306. Bypass valve 1322 can be used to test irrigation system 1300 and/or use bypass valve 1322 to divert aqueous nutrient solution from irrigation line 1306 until desired pH and other conditions are met.

FIG. 8 illustrates how an irrigation line 802 may be attached to grow line 202 to supply an aqueous nutrient solution to crops disposed in grow towers 50 as they translate through the vertical tower conveyance system 200. Irrigation line 802, in one implementation, is a pressurized line with spaced-apart apertures disposed at the expected locations of the grow towers 50 as they advance along grow line 202 with each movement cycle. For example, the irrigation line 802 may be a polyvinyl chloride (PVC) pipe having an inner diameter of 0.75 inches and holes having diameters of 0.125 inches. The irrigation line 802 may be approximately 40 meters in length spanning the entire length of a grow line 202. To ensure adequate pressure across the entire line, irrigation line 802 may be broken into shorter sections, each connected to a manifold, so that pressure drop is reduced and to achieve consistent flow rate across a line. Nutrient water delivery to the sections can be controlled with solenoid or on/off valves to allow for water to be supplied to only some subset of the grow towers 50 in a grow line 202.

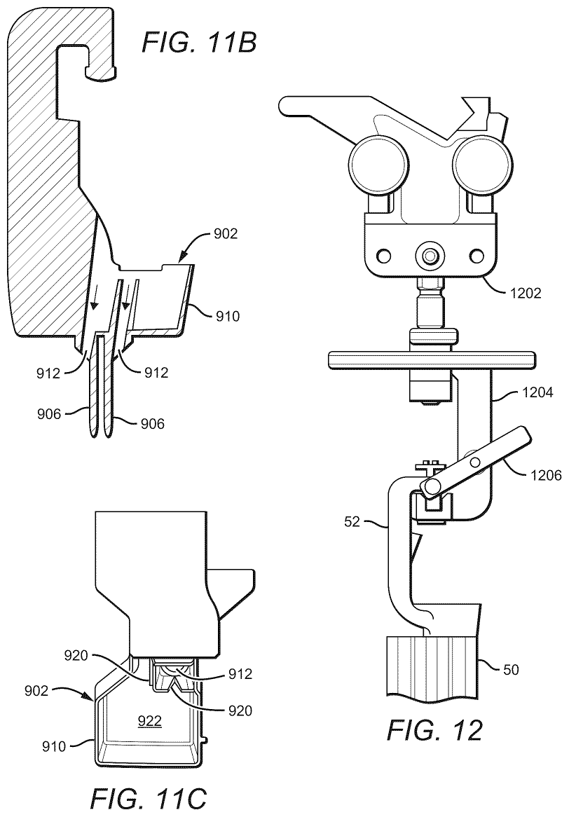

As FIG. 8 shows, a funnel structure 902 collects aqueous nutrient solution from irrigation line 802 and distributes the aqueous nutrient solution to the cavity(ies) 54a, 54b of the grow tower 50 as discussed in more detail below. FIGS. 9 and 11A illustrate that the funnel structure 902 may be integrated into hook 52. For example, the funnel structure 902 may include a collector 910, first and second passageways 912 and first and second slots 920. As FIG. 9 illustrates, the groove-engaging member 58 of the hook may disposed at a centerline of the overall hook structure. The funnel structure 902 may include flange sections 906 extending downwardly opposite the collector 910 and on opposing sides of the centerline. The outlets of the first and second passageways are oriented substantially adjacent to and at opposing sides of the flange sections 906, as shown. Flange sections 906 register with central wall 56 of grow tower 50 to center the hook 52 and provides additional sites to adhere or otherwise attach hook 52 to grow tower 50. In other words, when hook 52 is inserted into the top of grow tower 50, central wall 56 is disposed between flange sections 906. In the implementation shown, collector 910 extends laterally from the main body 51 of hook 52.

As FIG. 11B shows, funnel structure 902 includes a collector 910 that collects nutrient fluid and distributes the fluid evenly to the inner cavities 54a and 54b of tower through passageways 912. Passageways 912 are configured to distribute aqueous nutrient solution near the central wall 56 and to the center back of each cavity 54a, 54b over the ends of the plug holders 158 and where the roots of a planted crop are expected. As FIG. 11C illustrates, in one implementation, the funnel structure 902 includes slots 920 that promote the even distribution of nutrient fluid to both passageways 912. For nutrient solution to reach passageways 912, it must flow through one of the slots 920. Each slot 920 may have a V-like configuration where the width of the slot opening increases as it extends from the substantially flat bottom surface 922 of collector 910. For example, each slot 920 may have a width of 1 millimeter at the bottom surface 922. The width of slot 920 may increase to 5 millimeters over a height of 25 millimeters. The configuration of the slots 920 causes nutrient fluid supplied at a sufficient flow rate by irrigation line 802 to accumulate in collector 910, as opposed to flowing directly to a particular passageway 912, and flow through slots 920 to promote even distribution of nutrient fluid to both passageways 912.

Other implementations are possible. For example, the funnel structure may be configured with two separate collectors that operate separately to distribute aqueous nutrient solution to a corresponding cavity 54a, 54b of a grow tower 50. In such a configuration, the irrigation supply line can be configured with one hole for each collector. In other implementations, the towers may only include a single cavity and include plug containers only on a single face 101 of the towers. Such a configuration still calls for a use of a funnel structure that directs aqueous nutrient solution to a desired middle and back portion of the tower cavity, but obviates the need for separate collectors or other structures facilitating even distribution.

In operation, irrigation line 802 provides aqueous nutrient solution to funnel structure 902 that evenly distributes the water to respective cavities 54a, 54b of grow tower 50. The aqueous nutrient solution supplied from the funnel structure 902 irrigates crops contained in respective plug containers 158 as it trickles down. In one implementation, a gutter disposed under each grow line 202 collects excess aqueous nutrient solution from the grow towers 50 for recycling. In one implementation, the width of the gutter can be configured to be larger than the width of the grow towers 50 but narrow enough to act as a guide to prevent grow towers 50 from swinging. For example, the width of the gutter can be 0.5 inches larger than the width of the grow towers 50, and the walls of the gutter can be configured to extend an inch or more higher than the bottom of grow towers 50.

The apertures of irrigation line 802 can simply be holes drilled (or otherwise machined) into the pipe structure. Water, however, has a propensity to wick onto the surface of the pipe as it exits the apertures causing water to run along the pipe and drip down outside the funnel structure of the grow towers. In some implementations, the apertures can include structures directed to reducing or controlling possible leakage caused by the foregoing. For example, the apertures may be drilled holes with slotted spring pins pressed in, drilled holes with coiled spring pins pressed in, and drilled holes with a custom machined feature around the circumference made from a custom mill tool. All three of the solutions above are intended to create a sharp lip at the exit of the hole such that water cannot run along the pipe. Still further, separate emitters can be used at the select positions along the grow line 202.

Other solutions are possible. For example, an injection molded part with a sharp lip may be configured to snap into the aperture or hole drilled into the irrigation line pipe.

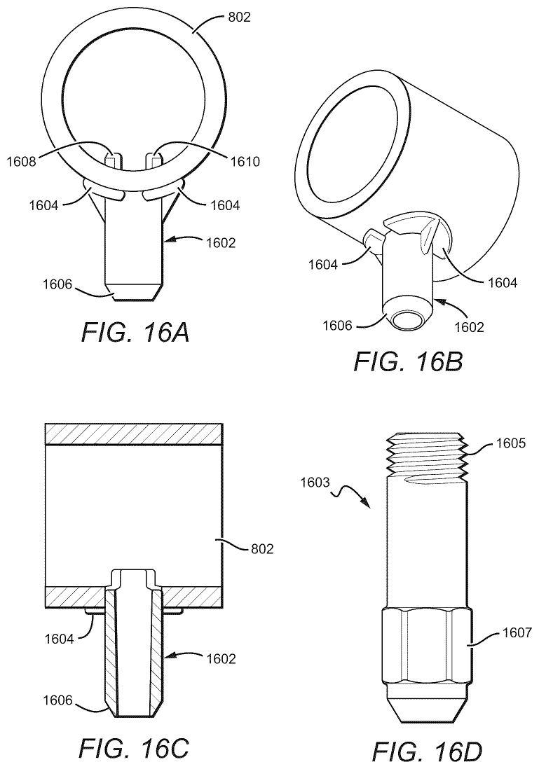

FIG. 16A is a section view of an irrigation line 802 including a nozzle 1602 attached to and extending from an aperture in irrigation line 802. FIG. 16B is a perspective view of nozzle 1602 attached to a section of irrigation line 802. FIG. 16C is a section view of nozzle 1602. As shown in FIGS. 16A and 16B, nozzle 1602 may include flanges 1604 to facilitate location and placement of nozzle 1602 in the apertures of irrigation line 802. In one implementation, nozzle 1602 may also include a small ridge or detent that engages the edge of the aperture at the inner surface of irrigation line 802 to allow nozzle 1602 to be snapped into place. Adhesives or ultrasonic welding can be used in addition to, or in lieu of, the small ridge to secure nozzle 1602. As the various figures show, nozzle 1602 includes a chamfered edge at the tip 1606 of nozzle 1602 to create a sharp transition to reduce water from wicking onto the outer surface of nozzle 1602. The upper portion 1608 of nozzle 1602 extending within irrigation line 802 may include a notch or slot 1610 to facilitate flow of nutrient solution out of irrigation line 802. Other implementations are possible. As shown in FIG. 16D for example, instead of pressing into a hole in the irrigation line 802, a nozzle 1603 may include threads 1605 which thread into a tapped hole of irrigation line 802. A seal may be formed between the threads of the nozzle and the line 802 and aided by a PTFE sealant (either thread tape or a paste). Such a nozzle 1603 may have a hexagonal portion 1607 extending along its body which allows it to be installed with a hexagonal drive tool.

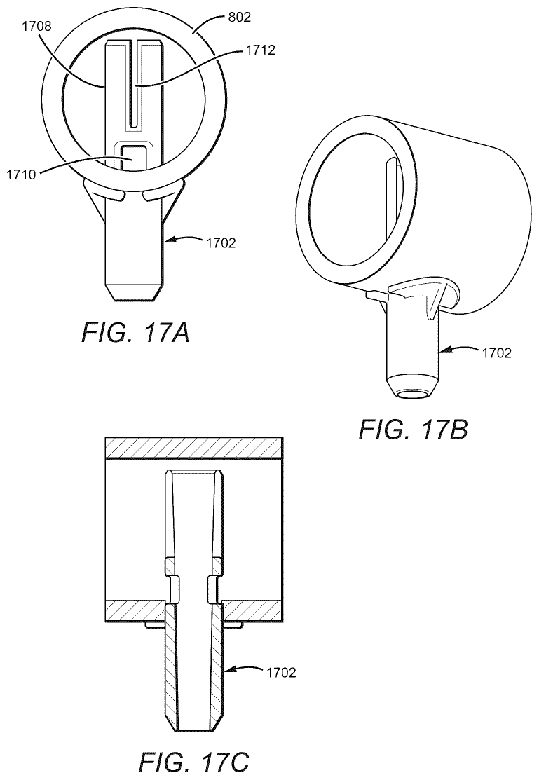

In one implementation, each aperture of irrigation line 802 may be fitted with nozzle 1602. In other implementations, the apertures at the second end (the end opposite the first end) of an irrigation line 802 (or the end of a section of irrigation line 802) may include an alternative nozzle 1702 including an air-bleed feature illustrated in FIGS. 17A, 17B and 17C. The air-bleed feature promotes consistent flow throughout irrigation line 802, as discussed in more detail below. In the implementation shown, the lower portion of nozzle 1702 is substantially the same as nozzle 1602. The upper portion 1708 of nozzle 1702 extends further into the interior of irrigation line 802 and includes slot 1810 and slit 1712. The extended upper portion 1708 facilitates bleeding air from irrigation line 802. Slit 1712 affords more room for water and air to facilitate their flow out of nozzle 1702.

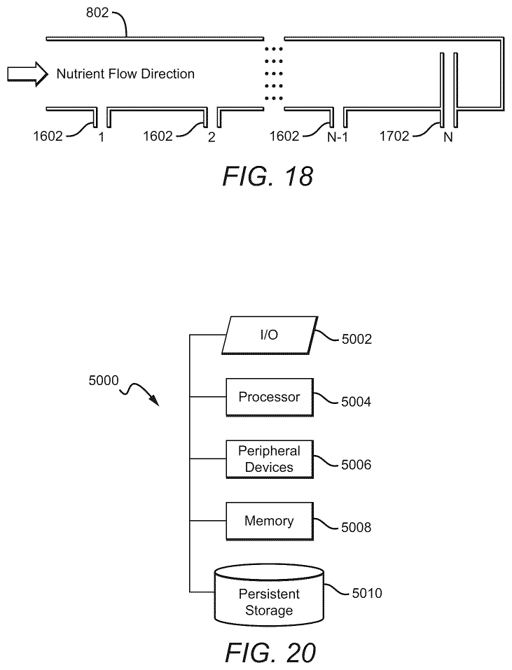

FIG. 18 is a schematic diagram illustrating an irrigation line for purposes of describing operation of the air-bleed feature described above. In various implementations, the irrigation system runs on a periodic basis in that the irrigation system is at rest between irrigation cycles. Between irrigation cycles, air fills the irrigation line 802 as the nutrient solution has drained off. At the beginning of an irrigation cycle (as the nutrient flow front moves into a section of irrigation line 802), air is pushed out of each nozzle 1602 until the nutrient solution passes a given nozzle. Once the front passes a given nozzle 1602, the nutrient solution starts to flow through the nozzle 1602 (instead of air). Nozzle N is the last nozzle to switch from air flow to nutrient flow. With this model for the nutrient flow when the irrigation cycle is started, the air flow though nozzle N should be the same if the upper portion of the last nozzle is short (i.e., matching nozzles (1602) 1, 2, . . . , N−1) or tall (to permit air venting) up to the time just before the nutrient front reaches nozzle N.

When the irrigation cycle begins and nutrient solution enters irrigation line 802, the solution pushes the air in the irrigation line 802 to the end of the line where it builds as one large pocket. With a nozzle having a shorter upper portion 1608, some of this air exits, but as the air is pushed out, water begins to cover the last (N) nozzle driving the air pocket above the water and above the last aperture. A new equilibrium is then obtained with water trickling out of the last aperture and a pocket of air sitting above the water. The air is then trapped and continues to exist in the line. Because the air takes up a volume, it prevents water from fully filling the irrigation line 802 thus creating flow out for the last aperture which is much less than at all other sites. Depending on the size of this air pocket, this weaker flow may exist for apertures (N−1, N−2, etc.) prior to the last (N) as well. The taller upper portion 1708 of nozzle 1702 allows for air to be constantly drained (i.e., small volumes of air at more frequent intervals). Because the top of the nozzle 1702 is at the top of inner surface of irrigation line 802 were the air pocket is located, air can always drain from this nozzle independently from the amount of water in the line. Unlike the shorter nozzle where a pocket of air may be trapped above the water in the line 802 and never able to exit (driving poor flow behavior), the longer nozzle 1702 allows air to more freely exit. In one implementation, the irrigation system supplies nutrient solution at a first end of the irrigation line 802. In such an implementation, nozzle 1702 is attached proximal to the second end of irrigation line 802 (or section of irrigation line 802). In other implementations, the irrigation system supplies nutrient solution to a middle portion of the irrigation line 802. In such an implementation, nozzle 1702 may be installed at both ends of irrigation line 802 (or sections thereof).

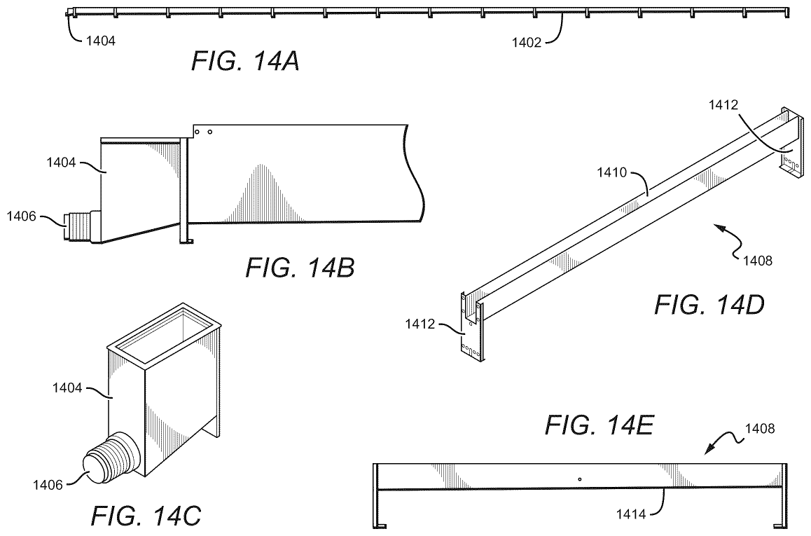

FIG. 14A illustrates an example gutter 1402 that can be disposed under a grow line 202 to collect excess aqueous nutrient solution from grow towers 50 attached to the grow line 202. In the implementation shown, gutter 1402 has a gradually-sloped (e.g., a 0.5% slope) bottom that causes excess nutrient solution to collect at end basin structure 1404.

FIGS. 14B and 14C show end structure 1404 in more detail. As FIGS. 14B and 14C illustrate, basin structure 1404 couples to the low end of gutter 1402 and includes an outlet 1406 to which a pipe, barb, or other structure attaches. As FIG. 13 illustrates, return pump 1312 operably connects with a hose, or pipe, to end structure 1404 to pump excess aqueous nutrient solution back to recirculation tank 1302, as discussed above. The return pump 1312 may be controlled by utilizing an ultrasonic sensor to maintain a certain water level in the gutter as well as a pump outlet pressure in order for the nutrient solution to return to the filter on the skid.

Gutter 1402 may consist of multiple separate sections that are joined together to form a unitary structure. FIGS. 14D and 14E illustrate an example gutter section 1408 according to embodiments of the disclosure. Gutter section 1408 may comprise a main body 1410 and flanges 1412. As FIG. 14E illustrates, the bottom 1414 of gutter section is sloped. As FIG. 14A shows, multiple gutter sections are joined at respective flanges 1412 to create gutter 1402. In one implementation, gaskets between flanges of adjoining gutter sections can be used to achieve a water tight seal. Flanges 1412 may also include feet sections to facilitate securing the gutter to a floor or other structure. As FIG. 14A further illustrates, gutter sections are similar to each other, but not identical. For example, the initial height of bottom 1414 of a given gutter section 1408 substantially matches the ending height of the bottom of an adjoining gutter structure. Similarly, the ending height of bottom 1414 of the gutter structure 1408 substantially matches the initial height of the adjoining gutter section. In this manner, the overall structure achieves a substantially continuous slope causing excess aqueous nutrient solution to flow to end structure 1404 for recirculation or disposal.

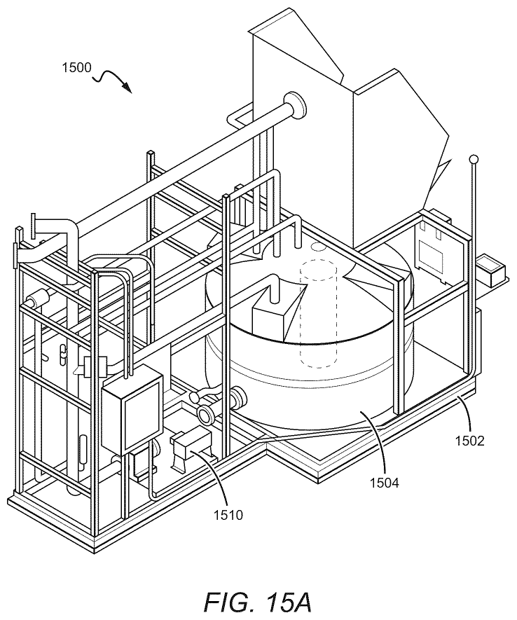

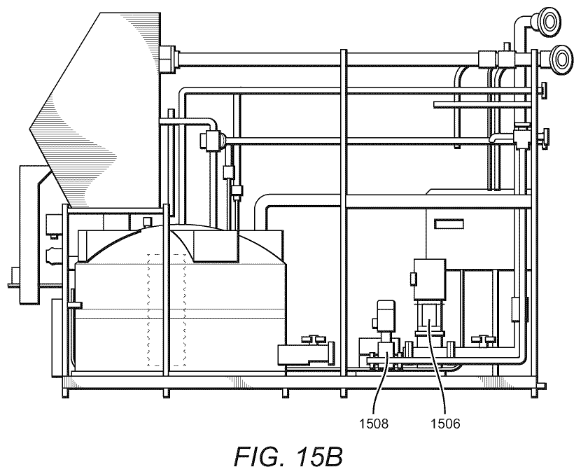

In one implementation, each grow line 202 is supported by a separate irrigation loop or zone that operates independently of irrigation loops associated with other grow lines in growth environment 20. In one implementation, each irrigation loop is supported by an irrigation skid that includes many of the components set forth in FIG. 13. Use of an irrigation skid allows for partial fabrication of the irrigation loop off site to lower overall costs of creating the crop production system. FIGS. 15A and 15B illustrate an irrigation skid 1500 according to embodiments of the disclosure. As FIGS. 15A and 15B illustrate, irrigation skid 1500 includes a frame 1502 onto which various irrigation components are mounted, such as recirculation tank 1504. In one implementation, irrigation skid 1500 also includes supply pump 1506, ozone supply pump 1508, and in-line pH dosing pump 1510.

Irrigation skid 1500 also includes plumbing, valves, sensors, a filter, cooling coil, electrical and control components to connect and operate the irrigation loop. In one implementation, other components illustrated in FIG. 13 may operate or support multiple irrigation skids.

For example, while irrigation skid 1500 includes ozone supply pump 1508 and associated plumbing, the remaining ozone cleaning components are separate from the skid and can be used to support multiple irrigation skids.

Nutrient and pH dosing system 1340, in one implementation, is operably connected to multiple irrigation skids 1500 by associated plumbing, valves and other controls. An irrigation control system controls valves and associated plumbing components as needed to interface nutrient and pH dosing system 1340, and associated sensors, with a given irrigation skid 1500. The Nutrient and pH dosing system has the ability to purge and rinse between dosing intervals, in order to prevent mixing of nutrient water from one recirculating loop to another. During operation, the nutrient solution in each recirculating irrigation loop is sampled on a predefined interval for that specific loop. During sampling, the ion levels of 8 separate nutrients may be checked and compared to the desired nutrient levels for that specific loop. Nutrient and pH dosing system 1340 may inject a nutrient dose to be delivered to the recirculation tank 1504 for that loop, based on the nutrient mix required and the room available in the tank for the water needed to transport the dose.

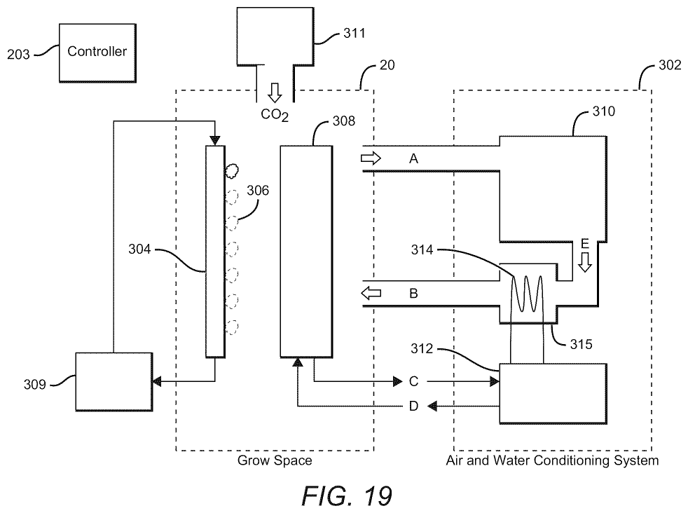

FIG. 19 illustrates a plant growing environment 20 and an environmental conditioning system 302 for conditioning air and fluid (e.g., water) in the grow space 20, according to embodiments of the disclosure. The plant growing environment 20 includes at least one receptacle support structure 304 (such as a tower 50) having receptacles for holding plants 306, and a fluid-cooled light fixture 308, according to embodiments of the disclosure.

An irrigation pump 309 circulates water and nutrients through the plant support structure 304. According to embodiments of the disclosure, gas mixture control equipment 311 provides carbon dioxide, nitrogen, and other gasses, whether alone or in combination, to the plants. The irrigation pump 309 and gas mixture control equipment 311 may be considered as part of the conditioning system 302, according to embodiments of the disclosure.

According to embodiments of the disclosure, the conditioning system 302 includes a dehumidifier 310, a fluid (e.g., water) conditioning system 312, and a heating coil 314 in heat exchanger 315. The dehumidifier 310 receives return air A from the grow space 101. The conditioning system 302 provides supply air B, having a temperature and relative humidity that is controlled to meet setpoints for desired operating conditions of the plants in the environment 20.

The fluid conditioning system 312 receives return fluid C from the fluid-cooled light fixture 308. According to embodiments of the disclosures, the fluid conditioning system 312 can control the fluid temperature by varying the fluid flow rate through the light fixtures 308. The fluid conditioning system 312 supplies to the fluid-cooled light fixture 308 a supply fluid D, having a temperature that is controlled to meet set points for desired operating conditions of the plants in the environment 20.

According to embodiments of the disclosure, waste heat from the fluid passing through fluid conditioning system 312 may be provided to the heating coil 314 in the heat exchanger 315 to heat air E that is output from the dehumidifier 310. The air heated by the coil 314 is output as heated air B to the grow space 20.

The controller 203 may control all the elements of the conditioning system 302, according to embodiments of the disclosure. The controller 203 may be implemented using programmed logic, such as a computer, a microcontroller, or an ASIC. The controller 203 may receive sensed parameters from sensors distributed throughout the plant growing environment 101 and the air and water conditioning system 302, according to embodiments of the disclosure. The sensors 204 may include sensors that sense environmental conditions such as temperature; humidity; air flow; CO₂; irrigation flow rate; pH, EC, DO, and nutrient levels of irrigation water; and light intensity, spectrum, and schedule. The controller 203 may use the sensed parameters as feedback to instruct the conditioning system 302 to control environmental treatments (e.g., temperature, humidity) of the plant growing environment 101, according to embodiments of the disclosure.

FIG. 21 illustrates an enhanced HVAC system 2100 including an economizer subsystem 2102 and an air conditioning subsystem 2104, according to embodiments of the disclosure. The economizer subsystem 2102 includes an intake vent 2106, an exhaust fan 2108, supply air ducts 2110, and return air ducts 2112. Each pair of supply and return air ducts 2110, 2112 circulate air within a zone in the grow space 20. Each supply air duct 2110 provides supply air SA. Each return air duct 2112 receives return air RA. The supply air ducts 2110 run down the aisle between pairs of grow lines 202 (not shown in this figure) of hanging grow towers 50, according to embodiments of the disclosure. (Those skilled in the art will recognize that “tower” and “receptacle support” may be used interchangeably herein as appropriate.)

The economizer 2102 includes an economizer intake damper XC01 2114 and an economizer exhaust damper XC03 2118. HVAC dampers FC04-FC09 2120 control the supply of air from air conditioning subsystem 2104 to the grow room zones. According to embodiments of the disclosure, the controller 203 may close the end dampers FC04 2120 and FC09 2120 at certain times of the day to drive more airflow at different canopy positions for specific plants. Air conditioning subsystem 2104 operates similarly to conditioning system 302 of FIG. 19. Air conditioning subsystem 2104 includes heat exchangers and HVAC supply fans 2202. A chiller 2204 provides hot and cold water to a dehumidifier system in the air conditioning subsystem.

The normal state of operation for the chiller 2204 provides both warm and cold water to the dehumidifier unit. Within the dehumidification unit are three proportional valves (TCV03, TCV02, and TCV01) that control the flow of warm and cold water to three heat exchangers 2306, 2304, 2200 that are used to heat (TCV03), cool (TCV02), and dehumidify (TCV01). The fans 2202 (SA Flow fans) blow air to the grow room 20, and dampers FC04-FC09 2120 are used to control the air flow to each of the supply ducting outputs of the line. Return Air is moved across the dehumidification coils to dehumidify the air. In normal operation mode, XC01 2114 and XC03 2118 are closed and XC02 2130 is open and no blending with outside air using economization is utilized.

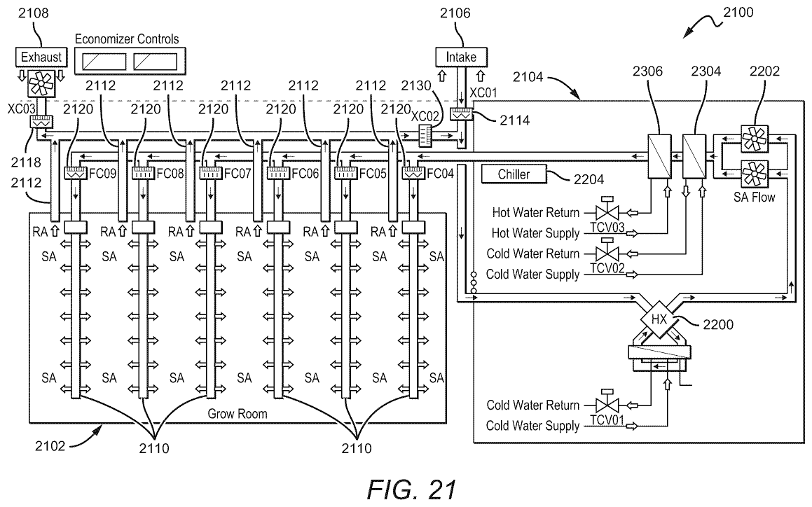

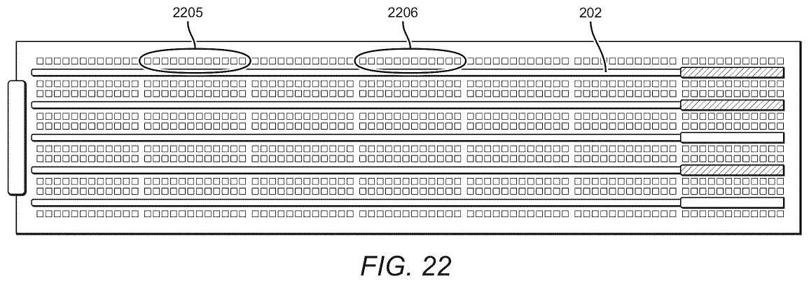

FIG. 22 illustrates a top view of the lighting assembly for a number of grow lines of receptacle supports (e.g., towers), according to embodiments of the disclosure. The figure shows five grow lines 202 horizontally. According to embodiments of the disclosure, linear arrays of lights are disposed on each side of a grow line 202. According to embodiments of the disclosure, the lights shine down from above the receptacle supports to illuminate the plants growing out of the sides of the receptacle supports. As shown, the lights may be grouped into sections (e.g., sections 2204, 2206).

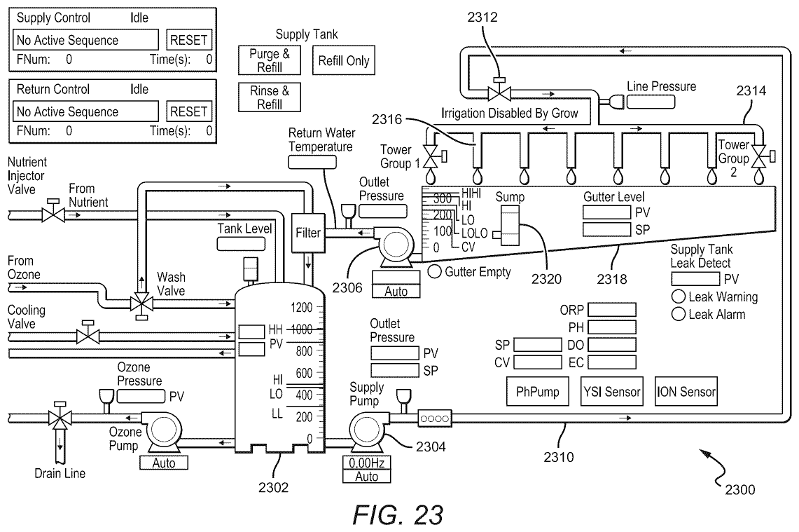

FIG. 23 illustrates an irrigation subsystem 2300 according to embodiments of the disclosure, including a water supply tank 2302, a supply pump 2304, a return pump 2306, a flow sensor, a supply line 2310, a zone master valve 2312, a lateral, main irrigation line 2314 from which branch irrigation lines 2316 branch off (shown for eight grow room sections), and a gutter 2318. The main irrigation line 2314 runs parallel to and above the grow line of vertical receptacle supports (e.g., towers). A nozzle at the end of each branch irrigation line 2316 allows water to spray down into a funnel disposed at the top of the vertical receptacle support, thus enabling irrigation of the plants supported by the receptacle support, according to embodiments of the disclosure. The gutter 2318 includes a gutter water level sensor and a sump pump 2320.

In operation, the supply pump 2320 pumps nutrient-enriched water from the supply tank 2302 through the supply line 2310 to the branch irrigation lines 2316 via the main irrigation line 2314. The water flows from the nozzles into the receptacle supports. Any water not retained in the receptacle supports flows into the gutter 2318.

The flow sensor monitors flow rate in the supply line 2310. The supply pump 2304, like many commercial supply pumps, provides an error signal in case of a pump malfunction. In response to an irrigation fault condition (e.g., the error signal or the flow rate falling below a desired threshold (e.g., 200 liters per minute)), the controller 203 executes an irrigation fail safe protocol, as follows according to embodiments of the disclosure: dim the lights (e.g., down to 10% of standard illumination) if the irrigation fault condition persists for a given time period, e.g., 10 minutes; turn off the lights if the irrigation fault condition persists for a further time period, e.g., 30 minutes more. According to embodiments of the disclosure, if the fault condition ends, the controller 203 turns the lights back on.

Indexing of Segmented Grow Tower Embodiments of the disclosure efficiently use the grow space by enabling increasing separation of plants as they grow in size, especially plants that are installed in vertical grow towers. Note that in the embodiments herein, the plants may be of many types, e.g., leafy greens or fruiting plants such as strawberries and tomatoes (e.g., dwarf tomatoes).

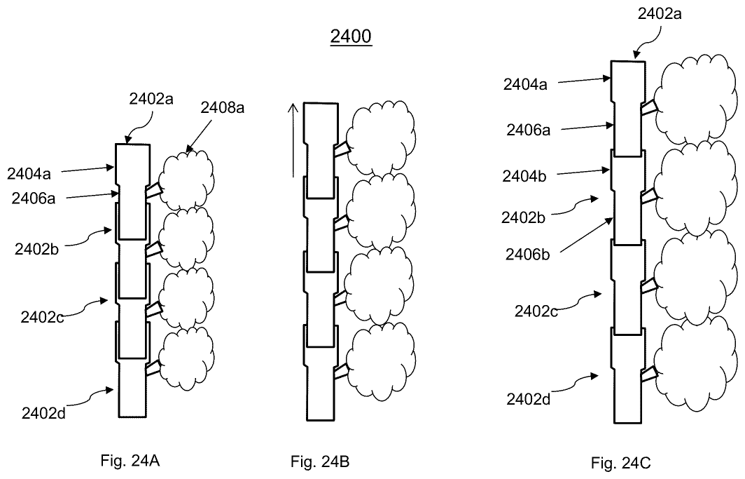

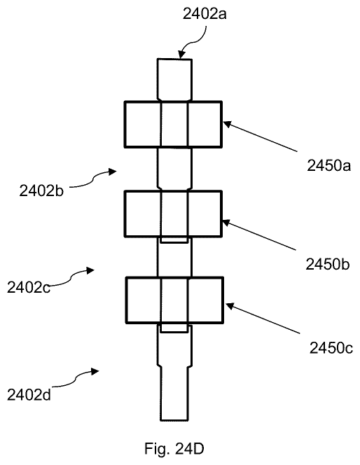

FIGS. 24A-24D illustrate vertical indexing using nested tower segments, according to embodiments of the disclosure. According to embodiments of the disclosure, a plant support structure 2400, such as a vertical grow tower, includes segments 2402 (e.g., 2402a, 2402b) for supporting plants 2408. A topmost segment 2402a may be attached to an overhead structure, such as a grow line conveyor.

Each segment may include a first end portion 2404 (e.g., 2404a, 2404b) and a second end portion 2406 (e.g., 2406a, 2406b). The first end portion 2404 may have a larger opening (e.g., larger diameter in embodiments where the segments are generally cylindrical, or larger width) than the second end portion 2406. The first end portion 2404 may include an opening into which the second end portion 2406 of an adjacent segment may slidably be moved in and out. For example, second end portion 2406a of top-most segment 2402a slidably couples to first end portion 2404b of adjacent segment 2402b. According to embodiments of the disclosure, instead of discrete first and second end portions 2404, 2046, each segment 2402 may comprise a continuous taper, such as a continuously tapered cylinder, with a first (e.g., top) end having a larger opening than the second (e.g., bottom) end.

Using mechanisms described herein or by hand, this slidable arrangement allows the distance between segments to be increased to accommodate growth in size of the canopies of the plants 2408, as shown in FIGS. 24A-24C. According to embodiments of the disclosure, the spacing need not be uniform.

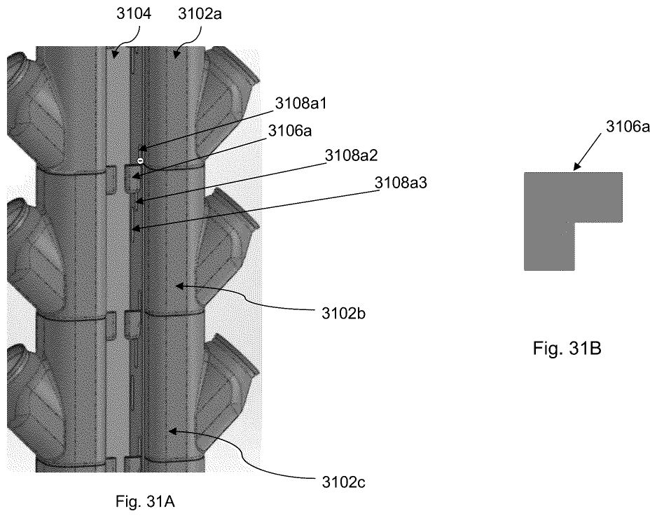

FIG. 31A illustrates a double-sided tower having tower segments 3102 attached to a common spine 3104 (otherwise referred to herein as a “rail” or “trunk”) via hooks 3106, according to embodiments of the disclosure. The spine 3014 includes slots 3108. Three slots (e.g., 3108a1, 3108a2, 3108a3) are shown here for each segment. FIG. 31A shows, for example, the hook 3106a resting in slot 3108a1. An upper portion of slot 3108a1 is visible, whereas the lower portion of the slot 3108a1 is concealed by the hook 3106a inserted through the slot 3108a1. FIG. 31B illustrates a side view of a hook such as hook 3106a.

The slots are positioned at different distances along the spine 3014. By positioning the hooks 3106 in different slots 3108, one may adjust the spacing between segments 3102 in discrete increments either manually or using an automated drive mechanism.

As shown, the hooks 3106 are integral with or attached to the segments 3102, and the slots 3108 reside in the spine 3104. Alternatively, the hooks 3106 may be disposed on the spine 3104 and the slots in the segments 3102. Those skilled in the art will recognize that interlocking connections (e.g., between an attachment projection and receiving elements) other than hook/slots may be employed, such as pins, ratchets, or clips connected to discrete features on the rail such as a series of holes or notches.

According to embodiments of the disclosure, segments 3102 may be moved continuously, instead of discretely, along the spine 3104, e.g., by attaching the segments 3102 to the spine 3104 via a spring grip mechanism similar to terminal blocks on a DIN rail.

FIG. 24D shows spacers 2450 (e.g., 2450a, 2450b) inserted between segments 2402 to hold the segments 2402 in their spaced apart arrangement. (The spacers 2450 may, for example, be an annulus.) Spacers 2450 of different widths may be used to vary the spacing.

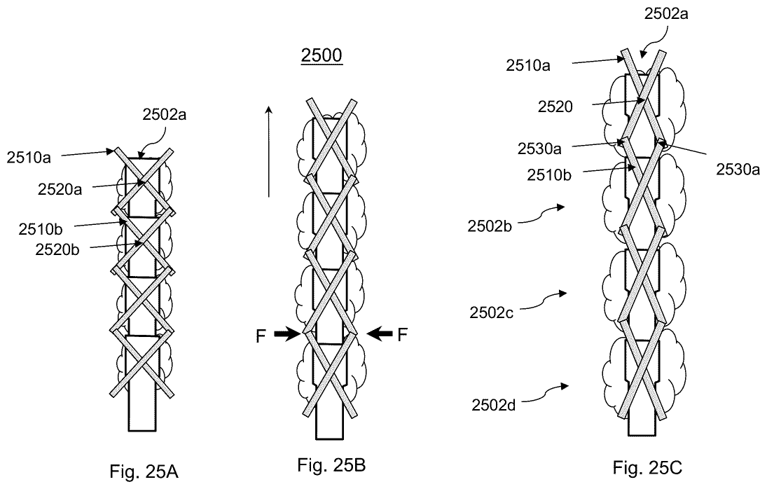

FIGS. 25A-25C illustrate vertical indexing of nested tower segments using a coupling mechanism, such as a scissor mechanism that comprises scissor links 2510 (e.g., 2510a, 2510b), according to embodiments of the disclosure. The nested tower segments 2502 may be identical or nearly identical to segments 2402 in FIGS. 24A-24D. Alternatively, the segments 2502 need not have the same shape and need not nest within each other. For example, they may be cylinders of uniform diameter throughout their length.

The nested-segment embodiment allows nutrient solution to flow from one segment to the next without leaking to the outside surface of the tower where it would be exposed to light and foster algae or other unwanted biological growth. The nesting feature can serve as a nutrient solution flow path in either of two main irrigation schemes: a) Nutrient solution is delivered to the top of the tower assembly and flows from one plant site to the next in series in order to supply nutrient solution to the root zone of each plant; or b) Nutrient solution is delivered to each individual plant site (e.g. at the top surface of the planting media) and flows in parallel through each plant capsule (i.e. container of media and roots) into the nesting portion of the tower segments which combine to serve as a common drain for the nutrient solution. In either case, the nesting design preserves this nutrient solution flow path while enabling relative motion between each plant site.

According to embodiments of the disclosure, the scissor mechanism comprises X-shaped links 2510 coupled together at link connections 2530 to form a repeating X pattern.

Each link 2510 may be attached at an attachment point 2520 to a corresponding segment 2502. When force F is applied laterally to the scissor mechanism, e.g., at connections 2530 between any two links 2510, the mechanism lengthens (translates the force in an orthogonal direction) so as to increase the distance between the segments 2502. Local actuation (e.g., force) applied to any single link 2510 result in motion of the entire scissor mechanism.

According to embodiments of the disclosure, the force F may be applied by hand, by robot, or by any actuator (such as a linear actuator) controlled by a controller such as controller 203. Of course, force may instead be applied to pull apart any X link 2510 to cause the scissor mechanism to contract and pull the segments 2502 closer together.

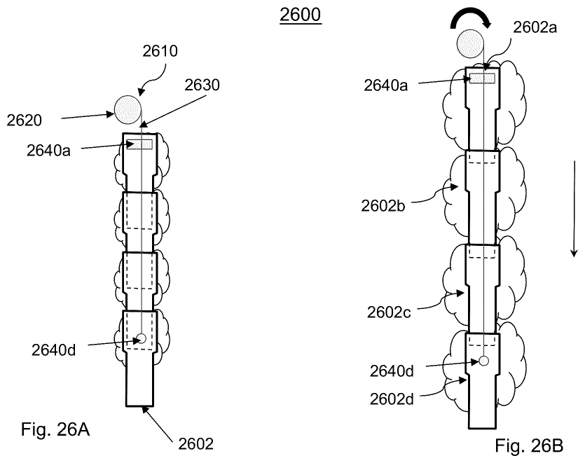

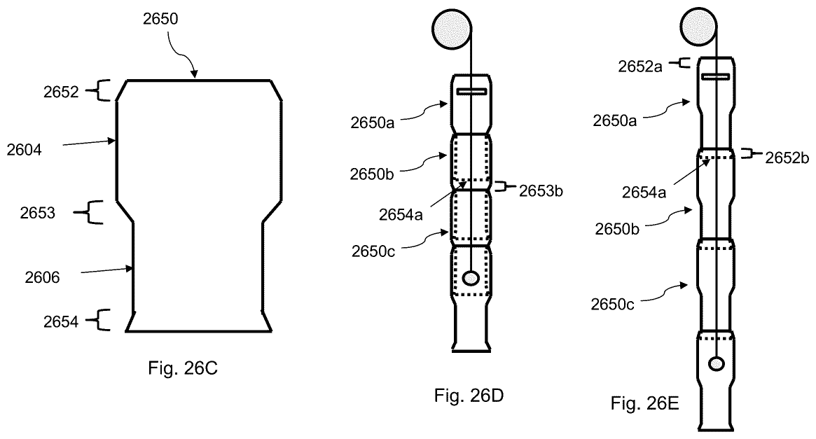

FIGS. 26A-26B illustrate vertical indexing of nested tower segments using a coupling mechanism, such as a cable hoist mechanism, according to embodiments of the disclosure. The nested tower segments 2602 may be identical or nearly identical to those in FIGS. 24A-24D. Alternatively, the segments 2602 need not have the same shape and need not nest within each other. For example, they may be cylinders of uniform diameter throughout their length.

According to embodiments of the disclosure, the cable hoist mechanism 2610 includes a cable holder (e.g., a reel) 2620 and a cable 2630. Cable holder 2620 and the topmost segment may be attached to an overhead structure (e.g., a grow line conveyor). The term “cable” in regard to the embodiments of FIGS. 26A-26B refers to any flexible material, such as a cable, wire, rope, or the like, that one of ordinary skill in the art would recognize as suitable. According to embodiments of the disclosure, although the cable is flexible (bendable), it is generally inelastic, i.e., not stretchable. According to embodiments of the disclosure, the cable 2630 may be attached to a bottommost segment 2602d at an attachment point 2640d. Guide 2640a may include a hole through which cable 2630 passes.

According to embodiments of the disclosure, the segments 2602 hang vertically suspended by the cable 2630. FIG. 26A shows the segments 2602 in an almost fully contracted arrangement. According to embodiments of the disclosure, an actuator such as a motor controlled by a controller such as controller 203, may rotate the cable holder 2620 in a clockwise direction to pay out the cable 2630 so that the weight of the segments 2602 results in an increase in the distance between segments 2602. According to embodiments of the disclosure, instead of using an active actuator to slacken the cable 2630, a friction brake mechanism may be used to allow the support weight to pull the cable from the holder 2620.

FIG. 26C illustrates a tower segment 2650, similar to that of segment 2402, which may be employed in the nested tower arrangements herein, according to embodiments of the disclosure. Segment 2650 includes a first stop 2652, a second stop 2653, and a projection 2654. The first stop 2652 at a top end of segment 2650 may take the form of a constriction, a collar, a flange having a radius that decreases in a direction away from the body of the rest of the segment 2650, or the like. The second stop 2653 may be the transition between a top portion 2604 and a bottom portion 2606 of the segment 2650. The second stop 2653 may take the form of a constriction, a collar, a flange having a radius that decreases in a direction from the top portion 2604 to the bottom portion 2606, one or more studs or other discrete radial projections, or the like. The projection 2654 from the bottom portion 2606 may take the form of a a lip or flange having a radius that increases in a direction away from the body of the rest of the segment 2650, one or more studs or other discrete radial projections, or the like.

FIG. 26D illustrates a cable hoist mechanism similar to that of FIGS. 26A and 26B using the segment 2650 in a fully retracted (contracted) state. As shown, the second stop 2653b of segment 2650b prevents segments 2650b and 2650c from sliding closer together.

Those skilled in the art will recognize that the segments herein include plant sites, according to embodiments of the disclosure.

FIG. 26E shows the cable hoist mechanism in a fully extended (telescoped) state. The interaction of the projection 2654a of segment 2650a and first stop 2652b of segment 2650b prevents segments 2650a and 2650b from sliding farther apart. According to embodiments of the disclosure, the mechanism may be operated in a binary fashion between the fully contracted and extended states with limits defined by the stops and projections of the segments.

Advantages of using a cable over a thicker spine/trunk such as spine 3104 are:
Weight: The cable employs much less material than a rigid trunk.
Transport: The wire is much lighter and less bulky than a rigid trunk. It can be coiled during shipping to make shipping logistics easier and less costly.
Installation: Similar to transport, it is easier to move a coiled cable into place in the farm and uncoil it in-situ, as compared to maneuvering a several meter-long rigid piece into place.
Design flexibility: The wire and hanging features could both be sourced from readily available off the shelf components, and the spacing between hanging features can be easily adjusted without the expense of costly tooling.

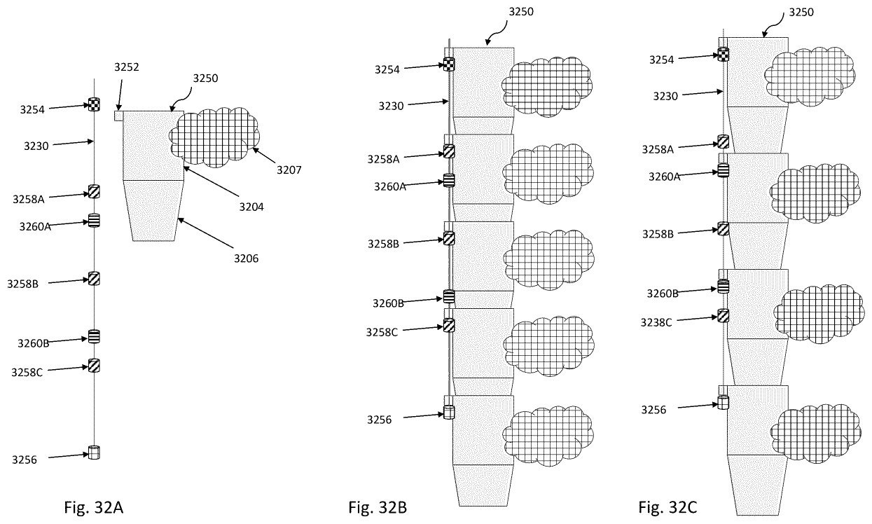

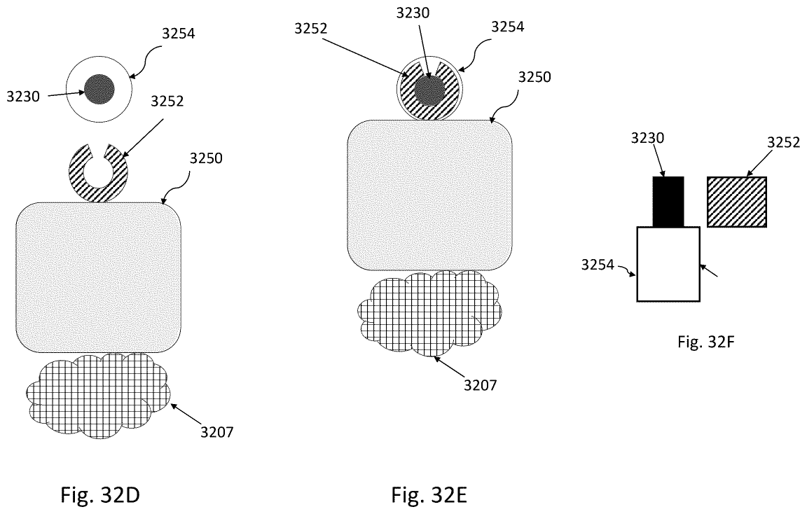

FIGS. 32A-32C illustrate vertical indexing of nested tower segments 3250 using a coupling mechanism, such as a cable 3230 with holds (alternatively referred to herein as “stops”) to adjust spacing between tower segments 3250, according to embodiments of the disclosure.

FIG. 32A depicts the cable 3230 and one segment 3250 when not engaged with the cable 3230, according to embodiments of the disclosure. Each segment 3250 may include a plant site to support a plant 3207 (e.g., an opening for insertion of a root structure (e.g., soil plug) of a plant 3207, a plug holder, or a plant container).

The slidably nested tower segments 3250 may be similar or nearly identical to segments 2402 or 2650 in FIGS. 24A-24D or FIGS. 26A-26E, except for projection 3252 (e.g., a proud or protruding geometry) of segments 3250. The cross-sectional shape of the segments in this and any of the other embodiments herein may be circular, square, generally rectangular, or any one of many other shapes.

Segments 3250 may include a first end portion 3204 (which may be, e.g., cylindrical) and a second end portion 3206 (which may be, e.g., a tapered hollow body).

Alternatively, the segments 3250 need not have the same shape as shown and need not nest within each other. For example, they may be cylinders of uniform diameter throughout their length.

According to embodiments of the disclosure, segment 3250 includes a projection 3252, which may, for example, be an open-ended collar, a twist-locking bayonet-style mount, a collar with a set screw, or an attachment that creates a tortuous path for the cable (potentially spring-assisted) to create enough frictional force to hold the segment 3250 in place (similar to belay equipment for grabbing ropes while climbing). In another embodiment, the segment need not include projection 3252, but may include a hole in the segment body to accommodate a set screw that clamps the cable 3230 directly.

FIGS. 32D and 32E depict top views of segment 3250 including its projection 3252 as an open-ended collar for engaging with a hold, such as top hold 3254 in this example. FIG. 32D depicts segment 3250 with projection 3252 not engaged with hold 3254, whereas FIG. 32E depicts segment 3250 with projection 3252 engaged with hold 3254. FIG. 32F depicts a side view of hold 3254 and collar 3252 while not engaged with each other, in this example.

In these examples, the projection 3252 is engaged with hold 3254 when it is (removably) secured to the cable 3230 and rests on the hold 3254. For example, the projection 3252 may be attached to the cable 3230 if the inner diameter of open-ended collar projection 3252 is large enough to snugly accommodate the diameter of the cable 3230, whereas the circumferential opening of the collar projection 3252 is slightly smaller than the diameter of the cable 3230 so that the cable 3230 may be snapped into (and out of) the collar projection 3252. The projection 3252 may be made of a flexible material to enable it to open slightly during insertion of the cable 3230.

According to embodiments of the disclosure, the cable 3230 may be attached to an overhead structure (e.g., a grow line conveyor). The term “cable” as to the embodiments of FIGS. 32A-32C refers to any flexible material, such as a cable, wire, rope, or the like, that one of ordinary skill in the art would recognize as suitable. According to embodiments of the disclosure, although the cable 3230 is flexible (bendable), it is generally inelastic, i.e., not stretchable. The cable 3230 may comprise one length of cable material (e.g., wire) or multiple segments of cable material joined together (e.g., at the hold locations).

Disposed along the cable 3230 are top and bottom holds 3254 and 3256, a first set of (upper) holds 3258 and a second set of (lower) holds 3260. The holds may be mechanically fastened to the cable 3230 by different means such as crimping, adhesives, or set screws. Each set of holds corresponds to a different spacing option for respective segments supported by the set of holds. Embodiments of the disclosure may comprise more than two sets of holds to enable more spacing options.

Referring to FIGS. 32B and 32C, according to embodiments of the disclosure, the segments 3250 hang vertically suspended by the cable 3230. FIG. 32B shows the segments 3250 in a fully contracted arrangement. FIG. 32C shows the segments 3250 in an extended arrangement. Because this example assumes a fixed height, FIG. 32C shows fewer (4) segments than FIG. 32B (5 segments) occupying same length.

In FIG. 32B, the projections 3252 are coupled to the cable 3230 to rest on the top hold 3254, the first set of holds 3258, and the bottom hold 3256. In FIG. 32C, projections 3252 are coupled to the cable 3230 to rest on the top hold 3254, the second set of holds 3260, and the bottom hold 3256. Because the spacing between the holds of the second set of holds 3260 is more than for the first set of holds 3258, the segments 3250 are spaced farther apart in FIG. 32C.

Similar to the use of a lead screw mechanism described above to index towers along a grow line, embodiments may employ a lead screw mechanism to vary the spacing of the segments so that spacing increases as the screw is rotated in one direction. For example, the screw may engage a hook, nut, or other projection on each segment, with the pitch of the thread varying to achieve an increase in spacing.

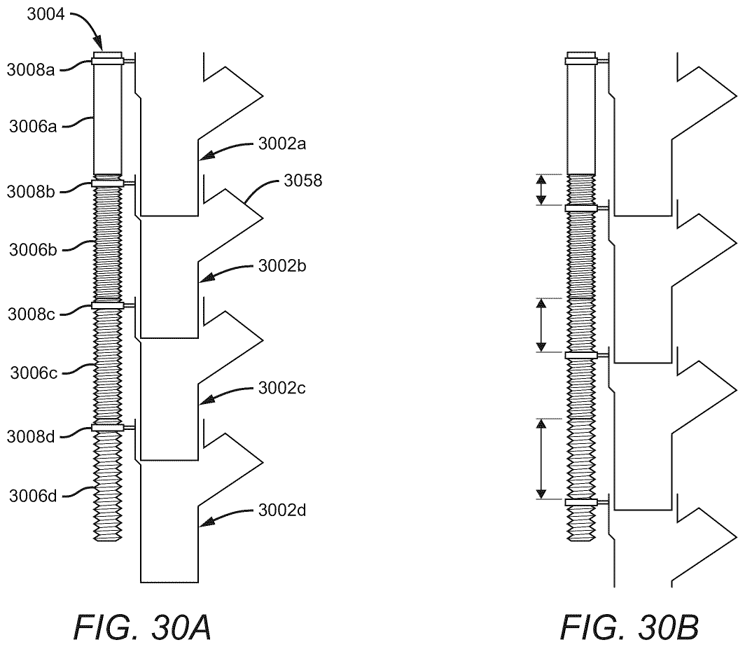

FIGS. 30A and 30B illustrated embodiments of the disclosure that couple segments 3002 with a varying-pitch lead screw 3004. FIG. 30A illustrates the tower segments 3002 in a contracted arrangement, whereas FIG. 30B illustrates the tower segments 3002 in a telescoped/extended arrangement. Each tower segment 3002 may include a plant growth module 3058. The screw includes segments 3006. According to embodiments of the disclosure, each screw segment 3006 has a different thread pitch with thread pitch increasing from top to bottom so that the bottom screw segment 3006d has the coarsest pitch. According to embodiments of the disclosure, the top screw segment 3006a need not be threaded at all.

According to embodiments of the disclosure, the relationship between thread pitches (spacing between threads) for each threaded segment (e.g., the second, third and fourth lowest segments in FIGS. 30A-30B) may be expressed as:
pitch=kP for k=1, 2, . . . , wherein P is the pitch of the first screw segment 3006b (topmost in the figure).

The screw segments 3006 may be attached to the tower segments 3002 via attachments 3008 such as threaded nuts attached to the segments 3002 with standoffs. For nut attachments, the pitch of each nut 3008 matches the pitch of its corresponding screw segment 3006. According to embodiments of the disclosure, the top attachment 3008a need not be threaded and need only allow the top screw segment 3006a to freely rotate.

According to embodiments of the disclosure, the top tower segment 3002a is fixed, whereas the other tower segments may move along the longitudinal axis. Because of the varying pitch of the screw 3004, rotation of the lead screw drives vertical indexing of the towers with the increasingly coarse thread pitch of the screw segments 3006 translating into greater vertical travel such that intra-tower spacing is consistent across all tower segments.

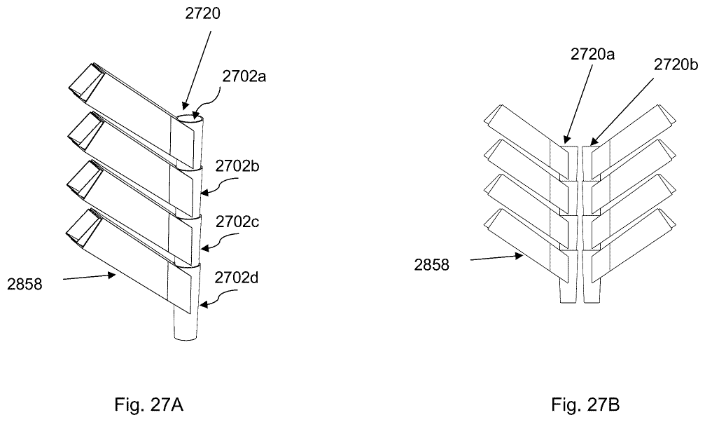

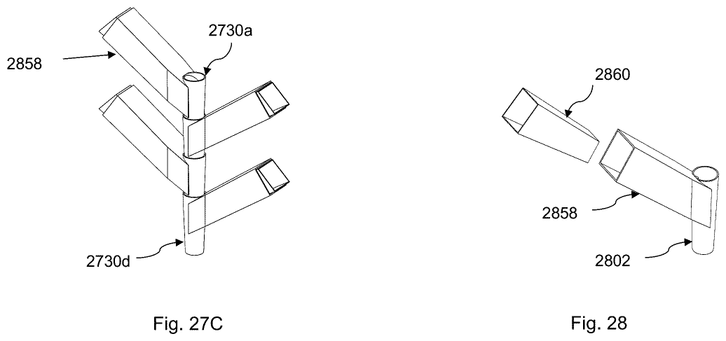

FIGS. 27A-27C illustrate embodiments enabling rotation of the segments to increase spacing. Referring to FIG. 27A, for tight spacing, all segments 2702a-2702d may face the same direction and form a single-sided tower 2720. Referring to FIG. 27B, in other embodiments, two single sided towers 2720a, 2720b may be arranged back-to-back to create a double-sided grow row. The segments may include plant holders such as receptacles 105 described above or plant growth modules such as modules 158 or 2858 described herein, the direction of which indicate the directions of the segments.

Alternatively, as shown in FIG. 27C, alternating segments 2730 may be rotated 180 degrees or at other angles about the longitudinal axis to create a double-sided tower with 2X spacing.

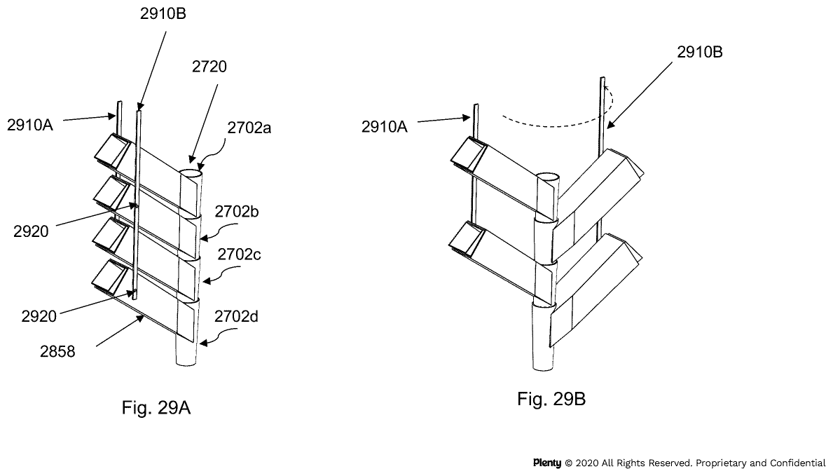

FIG. 29A is similar to FIG. 27A, but also includes vertical members (e.g., rails) 2910A and 2910B. According to embodiments of the disclosure, the plant growth modules 2858 are attached to the vertical members 2910A and 2910B at attachment points 2920 in an alternating pattern as shown. Rotating one member about the tower 2720 axis relative to the other member produces a desired rotational movement of alternating segments along the entire length of the tower 2720. These members could be used simply to facilitate rotational motion or additionally as the primary means of mounting and hanging tower segments from an overhead conveyance system. FIG. 29B (similar to FIG. 27C, but with vertical members) shows the segments rotated 180 degrees.

FIG. 28 illustrates a segment 2802, including a plant growth module 2858 and a removable plant capsule 2860, according to embodiments of the disclosure. Those skilled in the art will recognize that each of the segments in FIGS. 24-27 may employ segments such as segments 2802.

### Localized Irrigation and Plant Capsules Therefor

### Tower-specific Irrigation

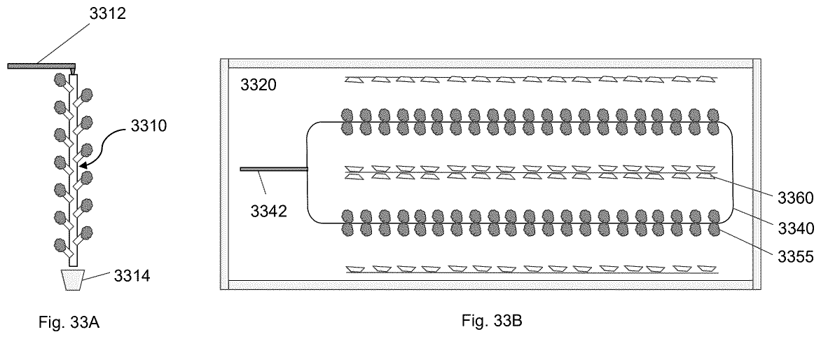

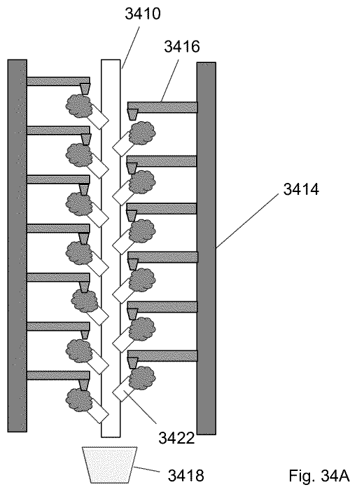

FIGS. 33A and 33B depict a localized irrigation system, according to embodiments of the disclosure. FIG. 33A shows a double-sided tower 3310, which may be identical or similar to the tower in FIG. 31A. The tower includes a trunk (otherwise referred to herein as a “spine”) 3104 supporting segments 3102. The segments 3102 may hold plant capsules. Each plant capsule may hold one or more plants.

The tower may be fed by an irrigation branch line 3312 that feeds a nutrient solution into an opening in the top of the tower to irrigate the roots and soil in the plant capsules. Gravity may cause the solution to travel down the (hollow) vertically-oriented grow tower 3310 and through the length thereof to supply solution to the crops disposed along the length of the grow tower. The water not absorbed by the tower may drain into a collection gutter 3314.

FIG. 33B shows an environmentally-controlled growing chamber 3320 (otherwise referred to as a “grow room” or “grow space”), according to embodiments of the disclosure, similar to grow chamber 20. Grow space 3320 includes a conveyance mechanism 3340 (e.g., track), similar to that of conveyance mechanism 200, to move the towers. As before, the conveyance mechanism may move the towers along grow lines from the grow space to a centralized location for processing (e.g., harvest, pruning, measurement, treatment application, transplanting).

A main irrigation line 3342 may feed the individual irrigation branch lines. The irrigation line 3342 may be collocated with the conveyance mechanism (collocated portion of irrigation line 3342 not shown explicitly). The grow space may also include rows or walls of lights directed to illuminate the plants in the towers.

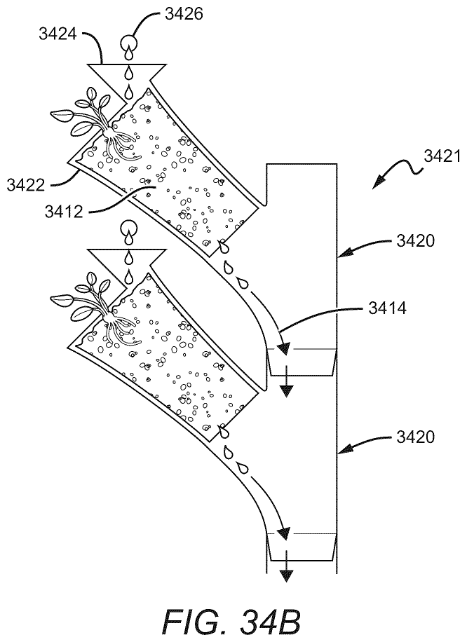

Individual plant site irrigation FIGS. 34A and 34B depict different approaches to localized irrigation, according to embodiments of the disclosure. FIG. 34A shows a double-sided tower 3410 similar or identical to that of tower 3310. Here, however, the irrigation system enables irrigation of each individual plant site 3422 that may hold a plant capsule 3412 that itself contains the plant media (e.g., soil and roots). According to embodiments of the disclosure, two vertical irrigation manifolds 3414 each provide nutrient solution to multiple irrigation branch lines 3416 to feed the solution into the plant media in each capsule 3412 on both sides of the double-sided tower 3410. The unabsorbed solution may flow into a cavity of the tower and drain into a collection gutter 3418.

FIG. 34B depicts a side sectional view of two stacked tower segments 3420 of a tower 3421 having plant sites 3422 containing plant capsules 3412. Each plant site includes a built-in funnel 3424. An irrigation supply 3426 (e.g., an irrigation branch line 3416) may provide nutrient fluid that flows into the funnel 3424, and then through the plant media in the capsule 3412. The fluid 3414 not absorbed by the media flows into a drainage channel in the tower 3420, and may eventually be collected by a gutter located near the bottom of the tower 3420.

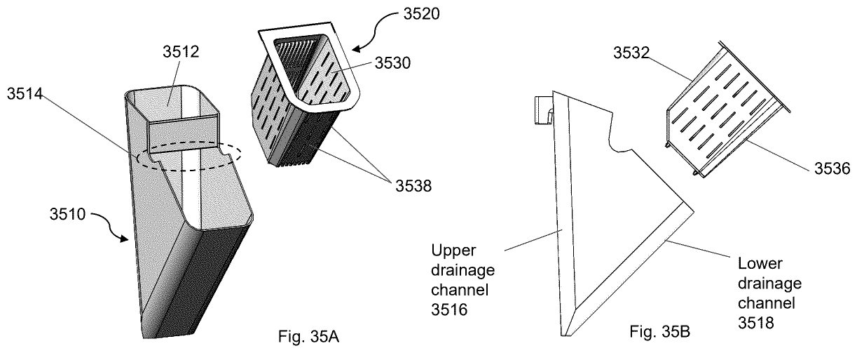

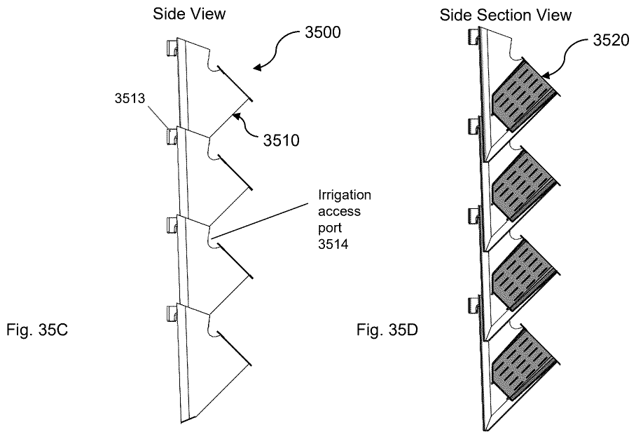

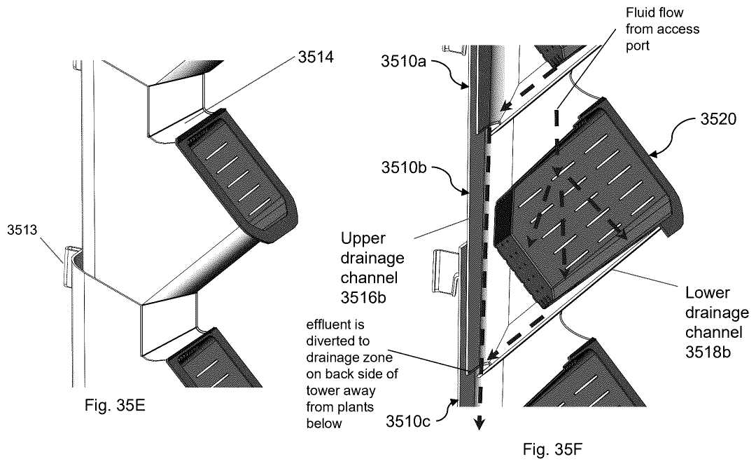

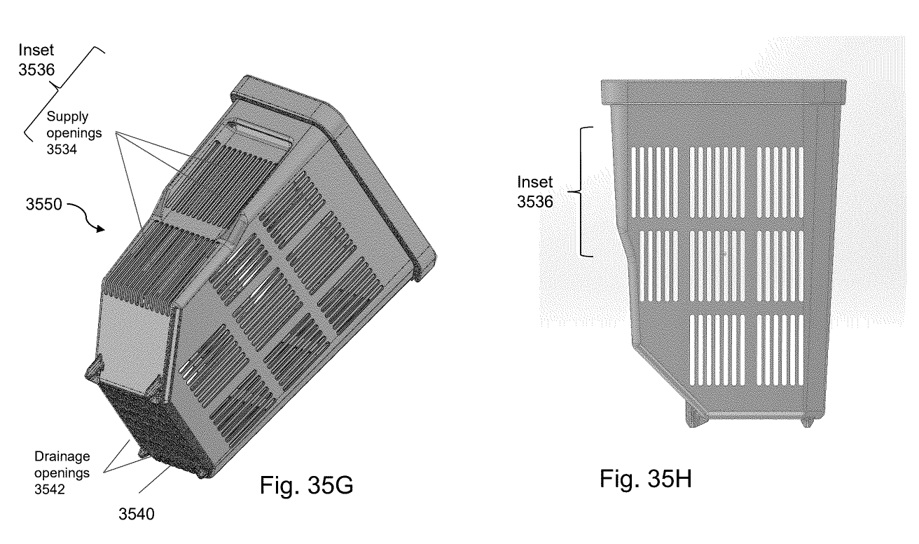

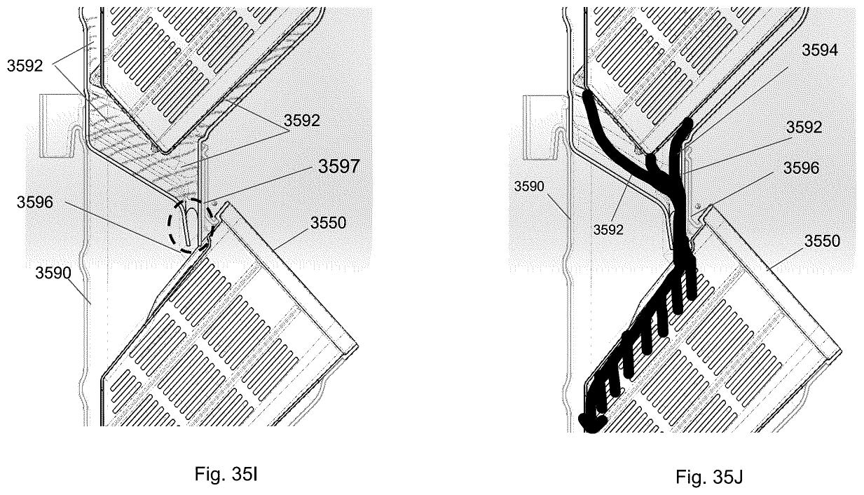

FIGS. 35A and 35B are, respectively, isometric and side sectional views of another embodiment of a tower body segment 3510 and a plant capsule 3520 that fits into the segment. The segment 3510 includes a top opening 3512 and an irrigation access port 3514 (shown encircled by a dashed ellipse).

With reference to FIG. 35B, the segment 3510 includes an upper (“first”) drainage channel 3516 and a lower (“second”) drainage channel 3518. The cavity formed by the top opening 3512 and excluding the drainage channels 3516 and 3518 forms a supply channel for the capsule 3520. The cavity receives the plant capsule 3520.

FIGS. 35C and 35D are, respectively, side and side section views of segments 3510 stacked together (e.g., via hooking to a trunk (not shown) with hooks 3513) to form towers 3500, with capsules 3520 inserted into the segments 3510, according to embodiments of the disclosure.

FIGS. 35E and 35F are, respectively, isometric and isometric section views of two of the segments 3510 stacked together. FIG. 35F shows the flow of nutrient solution, according to embodiments of the disclosure.

FIGS. 35G and 35H are, respectively, isometric and side views of a capsule 3550, according to embodiments of the disclosure. This capsule is similar to capsule 3520. The description herein of capsule 3520 generally applies to capsule 3550, and features of the two capsules will often be referred to interchangeably herein.

The capsule 3520 may include a top opening 3530 for receiving plant media such as a soil plug, a first surface 3532 having first openings (“supply openings”) 3534 (see, e.g., slots in FIG. 35G), a second surface 3536 having second openings (“drainage openings”) 3538 (see, e.g., slots in FIG. 35A). At least some of the first openings reside in an inset/recessed area 3536 of the first surface 3532 (see, e.g., FIG. 35G). Referring to, e.g., FIG. 35G, a third (e.g., bottom) side 3540 may also include third openings 3542 for drainage (more “drainage openings”). The inset 3536 helps to prevent splashing of the incoming fluid away from the supply openings. 3534.

FIG. 35I (without fluid) and 35J (with flowing fluid) depict fluid supply and drainage channels and fluid flow in stacked segments of other embodiments of the disclosure. Here, the segments 3590 include a drainage channel 3592 (shaded with lines) that directs draining fluid 3594 through a fluid redirecting outlet 3597 (enclosed by a dashed ellipse) on to the supply openings 3534 of the capsule 3550 below, instead of to a drainage channel in the lower segment as in some other embodiments. The fluid 3592 irrigates the plant medium through the supply openings of the capsule 3550 below.

The “open-sided” plant capsule designs of embodiments of the disclosure allows nutrient water to be evenly and efficiently delivered to the plant medium compared with prior capsule designs. Moreover, the rectangular profile of the segments allows for more efficient arrangement and volume usage of the towers in the grow space compared to previous cylindrical profiles.

According to embodiments of the disclosure, the towers are intermittently irrigated (e.g., a few times per day) and then rotated through the farm without irrigation. The tower designs of embodiments of the disclosure enable the plants to go longer between irrigation sessions because a greater media volume is soaked. Continuous watering results in roots protruding from the openings in the plant capsule (e.g., the drainage openings). These protruding roots get tangled and have to be removed and washed out. In contrast, intermittent watering results in much less root matter protruding from the capsule (“air pruning”).

Moreover, the dry period between intermittent watering sessions mitigates biofilm buildup on the towers and capsules.

Also, the irrigation approach of embodiments such as that of FIG. 35J allows nutrient water to be evenly and efficiently delivered from one tower body segment/plant site to the next one below. The irrigation approach of embodiments such as that of FIG. 35J reduces nutrient system complexity/demands by reducing the number of required irrigation events.

According to embodiments of the disclosure, the capsule 3520 need not have substantially flat sides or even easily identifiable “sides.” Instead, the sides may be curved or otherwise not flat, in which case the supply openings would be those openings oriented in a manner to receive fluid flowing to them via gravity or under pressure. Conversely, in that case, the drainage openings would be those openings oriented to enable passage of fluid flowing to lower drainage channel 3518 via gravity.

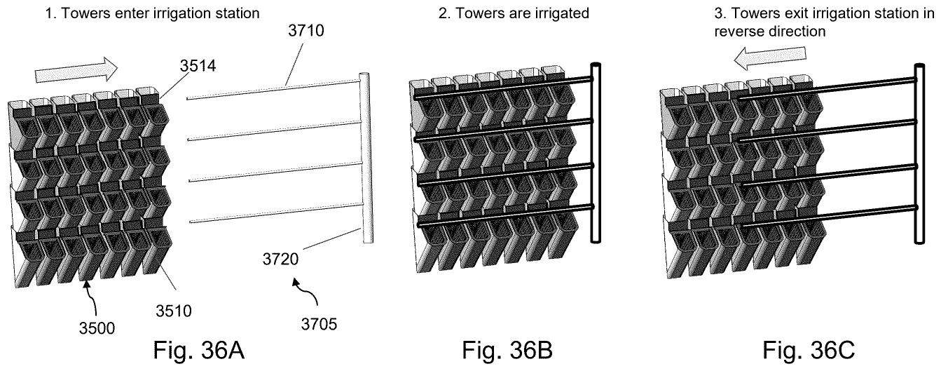

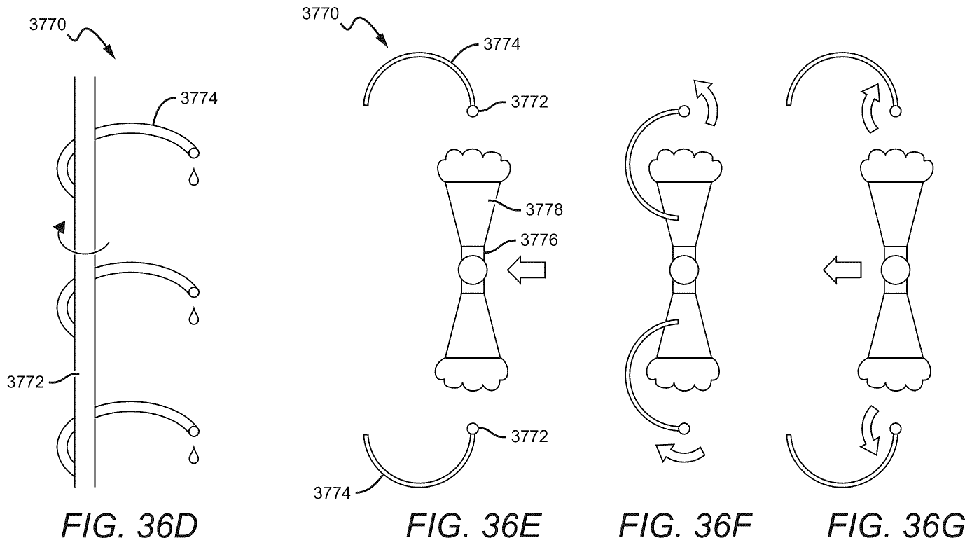

With reference to FIGS. 36A-36C, the irrigation access ports 3514 of segments 3510 of towers 3500 may accept branch irrigation lines 3710 (e.g., horizontal rigid rods).

Each irrigation line 3710 may branch from the vertical manifold 3720. Each branch line 3710 may include openings (e.g., perforations) in its surface to emit nutrient solution. The irrigation manifold 3720 and lines 3710 may be made of materials such as stainless steel or PVC.

As shown in FIG. 36B, via an automated mechanism or by hand, the set of towers 3500 may be moved so that the irrigation lines 3710 are inserted into the access ports 3514 of the set of towers. Thus, the irrigation assembly 3705 may irrigate in parallel individual plants sites (when capsules 3520 are inserted into the segments 3510) of multiple towers 3500. In this manner, the irrigation assembly may be said to individually irrigate a “matrix” of plant sites. Referring to FIG. 36C, after irrigation, the towers 3500 are removed from the irrigation assembly 3705 at the irrigation station.

In more detail, when the branch irrigation line 3710 is engaged with the access port 3514 of a segment 3510, it supplies nutrient solution to the supply channel in the segment. When the capsule 3520 is inserted into the segment 3510, it is inserted into the supply channel. According to embodiments of the disclosure, the towers 3500 may be double-sided towers, in which case the parallel set of irrigation branch lines (not shown) may stem off irrigation manifold 3720 or a parallel irrigation manifold (not shown) for insertion into the access ports 3514 of the segments on the other side of the tower 3500.

FIG. 35F shows the flow of the solution from the branch irrigation line 3710, according to embodiments of the disclosure. (The irrigation line 3710 has been omitted from the figure so as not to obscure the diagram.) As shown with dashed-line arrows, fluid flows down from the irrigation access port 3514 into the supply channel and through the supply openings in the capsule 3520. The fluid not absorbed in the capsule (referred to herein as “effluent”) flows out the capsule drainage openings into the lower drainage channel 3518, and continues into the upper drainage channel 3516 of the segment below.

FIG. 35F shows a full section view of a “second” segment 3510b, and partial section views of a “first” segment 3510a above, and a “third” segment 3510c below. The upper (“first”) drainage channel 3516b of the second segment 3510b is communicatively coupled to the first (upper) and second (lower) drainage channels 3516a, 3518a (not labeled in figure) of the first segment 3510a to receive draining fluid from those channels of the first segment. The second drainage channel 3518b of the second segment 3510b is disposed to receive fluid from drainage openings in the plant capsule 3520 in the second segment 3510b. The first drainage channel 3516c (not labeled in figure) of the third segment 3510c is communicatively coupled to the first and second drainage channels 3516b, 3518b of the second segment 3510b.

FIG. 36D is an isometric view of an irrigation assembly 3770, according to other embodiments of the disclosure. The irrigation assembly 3770 may include a main (e.g., vertical) manifold 3772 and branch irrigation lines 3774. As shown, the lines 3774 may be curved (e.g., a portion of a circle).

FIGS. 36E-36G are top views of the irrigation assembly 3770 irrigating double sided towers 3776. In FIG. 36E, the tower 3776 has been moved into position along the conveyance path. In FIG. 36F, the tower has stopped. The irrigation manifold 3772 rotates (either by hand or via an actuator, such as a motor) to engage the irrigation lines 3774 with the tower 3776 to deliver nutrient fluid to the plant media. The lines 3774 may engage with a port in the central tower body that connects to an irrigation channel that directs the fluid to the plant media or engage with an irrigation access port in the tower segment 3778 (as shown), or be positioned above a funnel in the tower segment such as funnel 3424 in FIG. 34B. As shown in FIG. 36G, after irrigation, the manifold 3772 rotates away from the tower 3776 to disengage, and the tower 3776 proceeds along the conveyance track.

### Tower Conveyance for Irrigating Double-Sided Towers

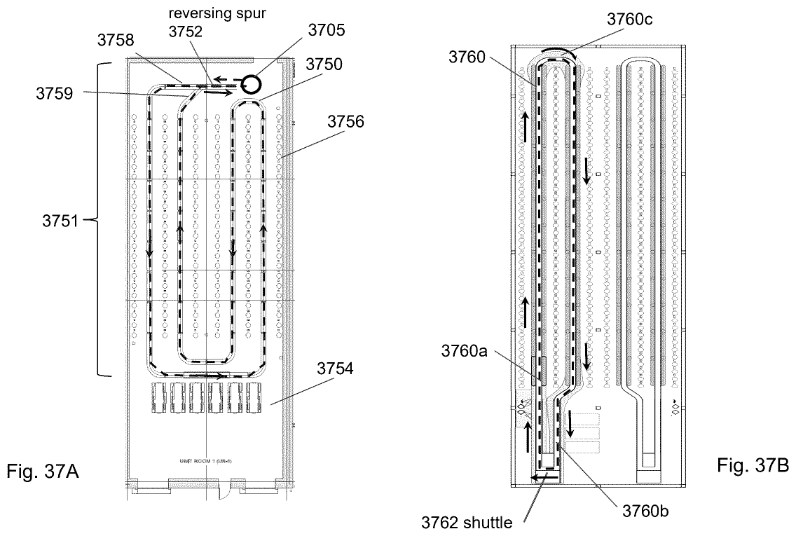

FIG. 37A is a top view of an example conveyance mechanism (e.g., track) 3750 in a grow space 3751. The track 3750 may convey double-sided towers comprising towers 3500 back-to-back, with each tower comprising the segments 3510 of embodiments of the disclosure. The path and direction of conveyance are highlighted by dashed lines and arrows. The grow space 3750 includes irrigation assembly 3705 including vertical manifold 3720 and two sets of branch lines 3710 for irrigating a set of double-sided towers. (The conveyance system embodiments may alternatively employ irrigation assembly 3770.) The grow space may include walls of lighting (e.g., LEDs) 3756 on both sides of the track 3750.

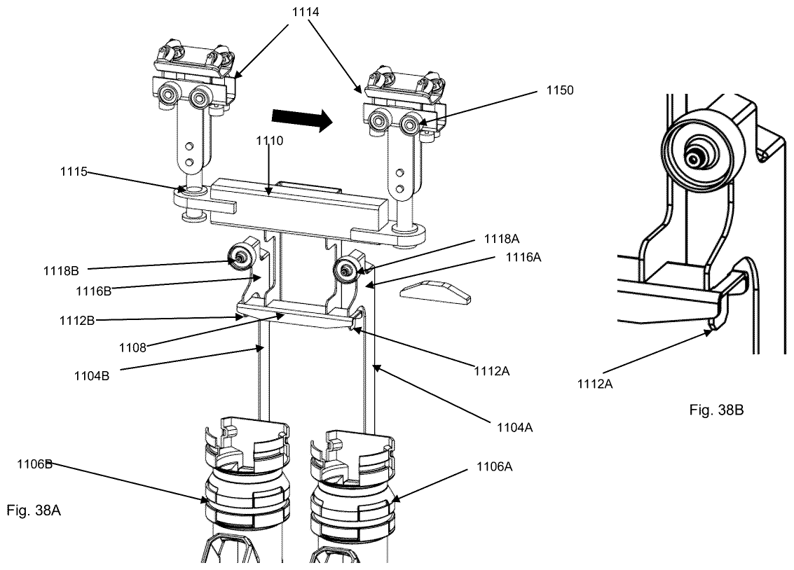

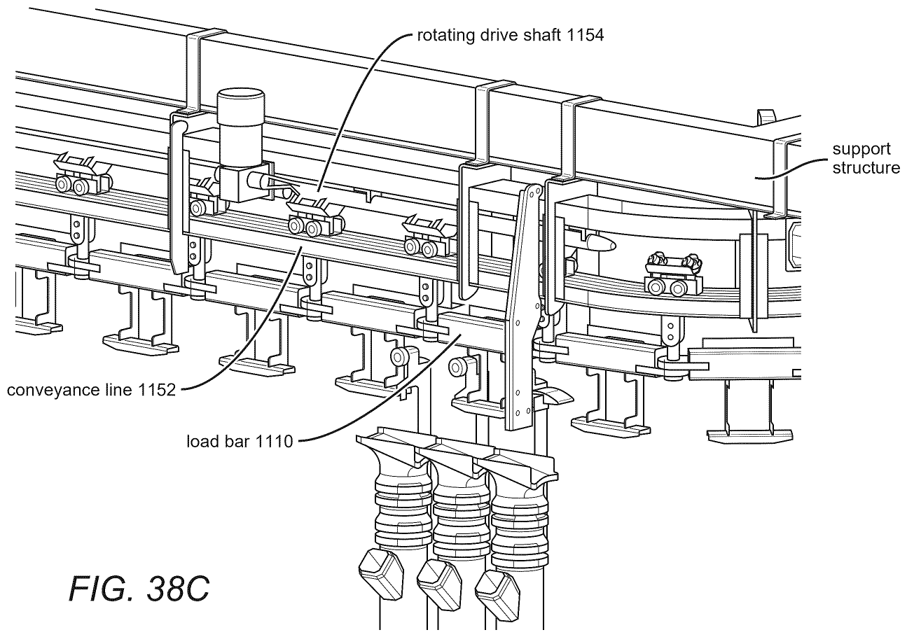

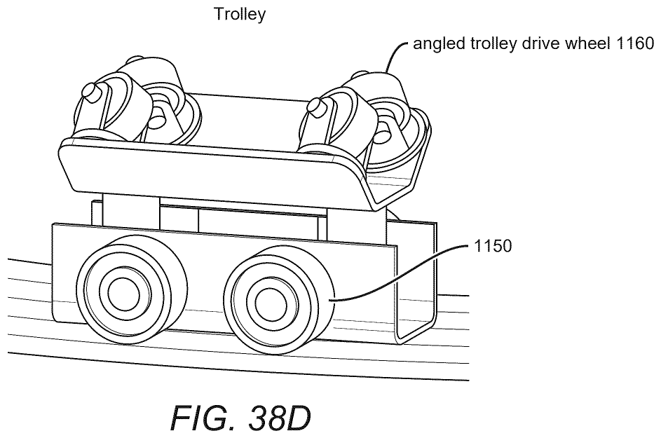

Referring to FIG. 38C, the conveyance mechanism 3750 may use an IntelliTrak 3500 series or AEMS style system in which groups of towers hang from a load bar such as load bar 1110 connected to a set of trolleys 1114 that ride on a conveyance line (track) 1152. See U.S. application Ser. No. 17/585,409, filed Apr. 4, 2022, which is incorporated by reference herein.

FIGS. 38A-38D depict the conveyance of plant support structures (e.g., towers 1106) along a conveyance line 1152, according to embodiments of the disclosure.

According to embodiments of the disclosure, a load bar 1110 depends from a carrier 1114, such as two trolleys. According to embodiments of the disclosure, a load bar may be a structure, such as a beam, which splits the load between multiple hangers, such as two trolleys. (In other embodiments, the load bar may hang from one hanger (e.g., trolley) and support only one tower.) The load bar 1110 may comprise one or more connections 1115 to couple the load bar 1110 to the carrier 1114. In embodiments, each connection 1115 may comprise a hole with a bushing to enable the load bar 1110 to turn easily as it is conveyed around curves or corners. In other embodiments, the connections may include fasteners such as screws or bolts, or include more fixed connections such as welds.

According to embodiments of the disclosure, a conveyance load bar is interposed between the load bar 1110 and the carriers 1114 to carry multiple load bars 1110. The conveyance load bar may hang from the trolleys 1114.

FIG. 38C illustrates conveyance of towers along a conveyance line 1152 similar to grow line 202, according to embodiments of the disclosure. FIG. 38D illustrates a magnified view of a trolley of FIG. 38A and FIG. 38C, according to embodiments of the disclosure. The carrier 1114 may include one or more rollers, one or more wheels 1150, a bearing surface (e.g., comprising a plastic material, for example a thermoplastic such as Delrin), or one or more gears to engage with conveyance line 1152, such as a load rail of the IntelliTrak 500 Series Overhead Conveyor (“Intellitrak 500”), manufactured by IntelliTrak Inc.

According to embodiments of the disclosure, the carrier 1114 is pushed along the conveyance line 1152 by a drive mechanism 1154 such as a drive tube of the IntelliTrak 500. The drive tube comprises a rotating drive shaft. The trolley includes drive wheels 1160 (different from wheels 1150) that are angled so that the trolley moves along the conveyance line 1152 when the drive tube 1154 rotates.

Tower hooks 1104A and 1104B of grow towers 1106A and 1106B rest on a lower ledge 1108 of the load bar 1110. According to embodiments of the disclosure, the lower ledge 1108 includes openings near both lateral ends of the ledge 1108, each opening for receiving a tip 1112A, 1112B of each tower hook 1104A, 1104B, respectively.

FIG. 38B shows a magnified view of tip 1112A. Each tower hook 1104A, 1104B includes an extension portion 1116A, 1116B, attached to which is a tower hook wheel 1118A, 1118B. The body of each of these grow towers 1106A and 1106B may be similar to that of a grow tower 50, except that each includes a hook 1104 with a tip 1112, and an extension portion 1116 with a wheel 1118.

The load bar 1110 is shown supporting two grow towers 1106A and 1106B. According to embodiments of the disclosure, the growing chamber 120 may include 100 grow towers 1106A and 1106B supported by 50 load bars 1110. According to embodiments of the disclosure, the skilled artisan would recognize how the load bar 1110 may be modified to support just one grow tower or more than two grow towers. In particular, more grow towers may be accommodated by including more than two openings in the lower ledge 1108.

In FIG. 38A, the weight of each tower 1106A, 1106B is borne by the respective hook tip 1112A, 1112B on the lower ledge 1108 of the load bar 1110.

Each tower hook wheel 1118A, 1118B may generically be referred to as a “moveable element,” which may comprise one or more wheels, one or more rollers, a bearing surface, one or more gears, or the like.

Although FIG. 38C does not depict the same towers as double-sided towers comprising towers 3500, the conveyance mechanisms in FIGS. 37A and 37B carry double-sided towers comprising towers 3500 back-to-back, according to embodiments of the disclosure.

In FIG. 37A, the track 3750 includes a return end portion 3759 and a forward end portion 3758. As the towers at the return end 3759 approach irrigation assembly 3705, their access ports 3514 engage with the branch lines 3710, so that the matrix of capsules 3520 may be irrigated. Note that the reversing spur approach is especially suitable for use with irrigation assembly 3705 because, if the towers were instead to continue travel in the same direction along a track, they would run into the irrigation assembly 3705. This is, however, not an issue with irrigation assembly 3770, where the irrigation manifold 3772 moves the irrigation lines 3774 out of the way after irrigation.

According to embodiments of the disclosure, after irrigation the conveyance mechanism 3750 may move the double-sided towers through a reversing spur 3752 and onto the forward end 3758. In the IntelliTrak system, for example, the reversing spur 3752 may be implemented by a switch. The switch receives the towers coming in one direction on the return end portion 3759, and switches the track so that the towers are sent out onto the forward end portion 3758 in a reverse direction, as indicated by a change of direction of the arrows. In this manner, the leading edge of the towers arriving at the reversing spur/switch becomes the trailing edge of the towers departing from the reversing spur/switch.

The spur 3752 reverses the orientation of the towers so both sides of the towers can ultimately be accessed in the vertical processing area 3754 by a robot or human harvester from just one side of the conveyance mechanism 3750. Thus, the harvester need not work from inside of the loop formed by conveyance mechanism 3750.

FIG. 37B is a top view of another example conveyance mechanism (e.g., track) 3760 in a grow space. The track 3760 may convey double-sided towers comprising the segments 3510 of embodiments of the disclosure. The path and direction of conveyance are highlighted by dashed lines and arrows. The track 3760 includes a forward section 3760a, a return section 3760b, and a turn 3760c.

Although not shown in this figure, like FIG. 37A the grow space may include an irrigation assembly 3705 including vertical manifold 3720 and two sets of branch lines 3710 for irrigating the double-sided towers, or irrigation assembly 3770.

Instead of using a reversing spur, this embodiment employs a shuttle 3762 such as that found in an IntelliTrak 3500 series conveyance system. The towers are irrigated, e.g., at an irrigation station, along the path 3760 before arriving at the shuttle 3762.

The shuttle 3762 laterally translates a set of towers from the return track section 3760b to the forward track section 3760a. To do so, the shuttle 3762 may remove from the return track section 3760b a load bar that carries the set of towers, laterally translate (without any rotation) the load bar (to the left in this figure), and attach it to the forward track section 3760a. In this manner, the leading edge (in the direction of conveyance) of the set of towers in the return section 3760b now becomes the trailing edge in the forward section 3760a, and the other side of the double-sided towers now faces outward. Like the previous conveyance embodiment, this enables both sides of the towers to ultimately be accessed by a robot or human harvester from just one side of the conveyance mechanism 3760.

By using an overhead conveyance system to convey towers to a local irrigation station, the local irrigation approaches of embodiments of the disclosure eliminate the distribution of irrigation manifolds, emitters, and collection gutters to all tower positions throughout room. They substantially reduce the total flow rate capacity of nutrient system, and enable more frequent deep cleaning of the nutrient system by decoupling irrigation site from plant grow sites. The plant varieties in the towers may be the same as those mentioned elsewhere herein, e.g., leaf vegetables, fruiting vegetables, flowering crops, fruits, and the like.

### Tower Indexing Via Interleaving

According to embodiments of the disclosure, towers are “interleaved” to enable an indexing step in a manner that is compatible with a fruiting crop loop style conveyance architecture. According to embodiments of the disclosure, the interleaving towers may employ two types of load bars: tower load bars and conveyance load bars. According to embodiments of the disclosure, each tower load bar carries a group of towers spaced at “1X” density. Conveyance load bars may be connected to the conveyance trolleys/running gear and are propelled by the conveyance system. According to embodiments of the disclosure, a conveyance load bar can carry one tower load bar (resulting in 1X density of plants on the conveyance load bar) or two or more tower load bars, arranged with the towers interleaved with one another such that towers are spaced at “2X” or greater density in a multiplexed manner.

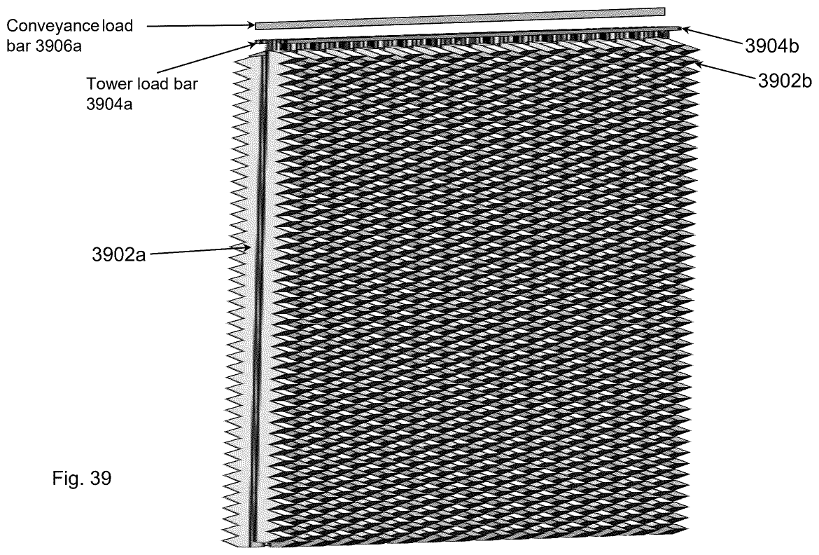

FIG. 39 illustrates two sets of plant support structures, e.g., a first set of grow towers 3902a (light shading) and a second set of towers 3902b (dark shading), interleaved in a high density arrangement, according to embodiments of the disclosure. In other embodiments, the arrangement may include more than two sets of support structures. For example, first, second and third sets may be interleaved as t1, t2, t3, t1, t2, t3. . . , where ti represents a tower from set i.

According to embodiments of the disclosure, each set of towers may be suspended from a corresponding tower load bar 3904. Here, the first set of double-sided grow towers 3902a (light shading) is suspended from a first tower load bar 3904a (light shading), and the second set of double-sided towers 3902b (dark shading) is suspended from a second tower load bar 3904b (dark shading). Each tower load bar 3904 may have a structure similar or identical to load bar 1110.

All sets of tower load bars 3904 may themselves be suspended from a conveyance load bar 3906a that may itself be connected to running gear or a carrier such as carrier 1114 that may include at least one trolley. For example, the first and second tower load bars 3904a, 3904b may be suspended from the conveyance load bar 3906a such that the towers 3902a, 3902b of the first and second sets of towers are interleaved, as shown in the figure. To do this, the towers from one set of towers that are suspended from a tower load bar must be spaced sufficiently apart from each other to leave room for an interposed tower from another set of towers.

FIG. 38A shows only two towers suspended from a tower load bar, and FIG. 38C shows only three towers suspended from a tower load bar without enough space to accommodate towers interposed between the towers shown in the figure. FIG. 39 shows many more towers suspended from each tower load bar with enough space between towers to accommodate interposed towers from another set.

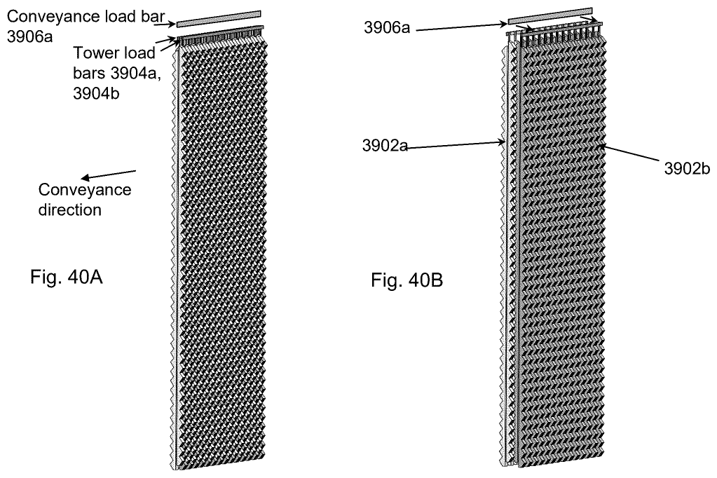

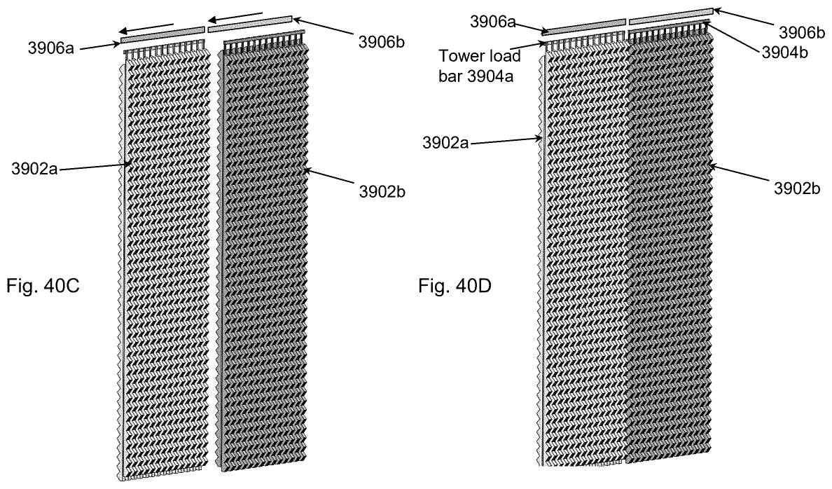

FIGS. 40A-40D depict tower indexing from a high density arrangement to a low density arrangement to provide more space for the plants residing at tower plant sites as the plants grow.

In FIG. 40A, tower load bars 3904a, 3904b are suspended from one conveyance load bar 3906a so that respective sets of towers 3902a, 3902b are interleaved at high (2X) density.

In FIG. 40B, an actuator, such as a linear motor, moves the second tower load bar 3904b perpendicular to the direction of conveyance to separate the second set of towers 3902b from the first set of towers 3902a. The actuators described herein may be under control of a controller, such as controller 203.

In FIG. 40C, the same or a different actuator (e.g., drive shaft driving trolley carrier) advances the first set of towers 3902a along the conveyance path, and the same or a different actuator advances a second conveyance load bar 3906b along the conveyance path.

In FIG. 40D, the same or a different actuator (e.g., linear actuator) moves the second set of towers 3902b in a direction perpendicular to the conveyance path to engage (e.g., suspend) the second tower load bar 3904b with the second conveyance load bar 3906b. The two sets of towers 3902a, 3902b are now aligned side by side in a lower density (1X) arrangement.

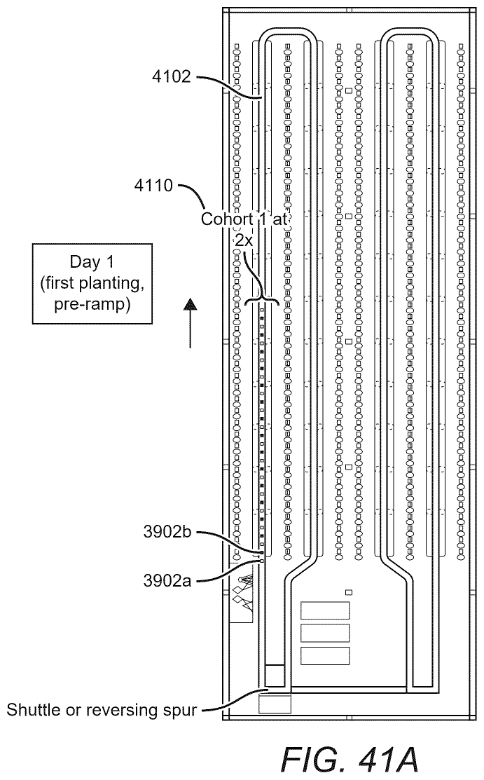

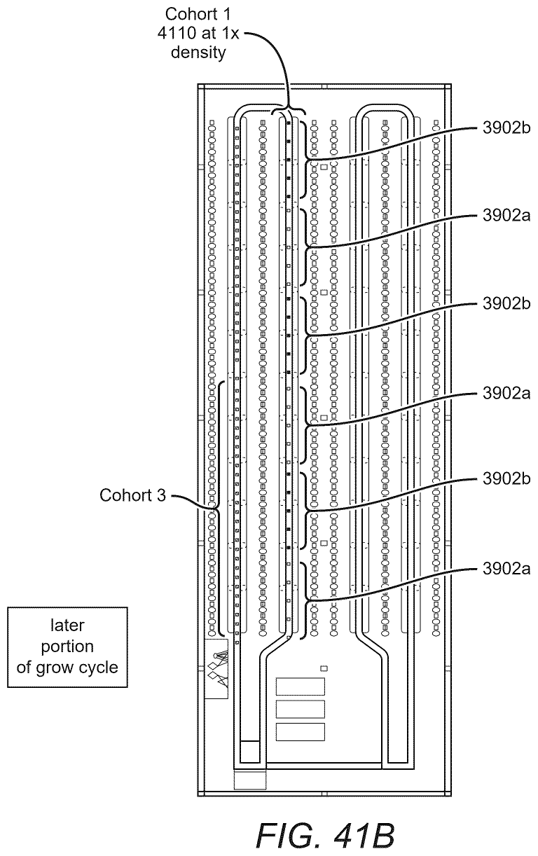

FIGS. 41A-41B depict de-interleaving of towers during a grow cycle as they move along a conveyance track 4102 similar to track 3760. In FIG. 41A, first and second sets of towers 3902a (lighter shade) and 3902b (darker shade) of a first cohort 4110 of towers are interleaved in a high density (2X) arrangement.

In FIG. 41B, the first and second sets of towers 3902a, 3902b have been deinterleaved to achieve a lower density (1X) arrangement, thereby providing more room for the plants as they grow. In this case, the first cohort 4110 includes 30 towers and the deinterleaving results in six alternating sets of five towers. According to embodiments of the disclosure, this may be achieved by starting with three conveyance load bars 3906, each holding two sets of five towers. Then, actuators may deinterleave the sets of towers and advance one set in each pair to make space to introduce a new conveyance load bar 3906 and to attach the removed set of towers to the new conveyance load bar 3906 for each pair of sets.

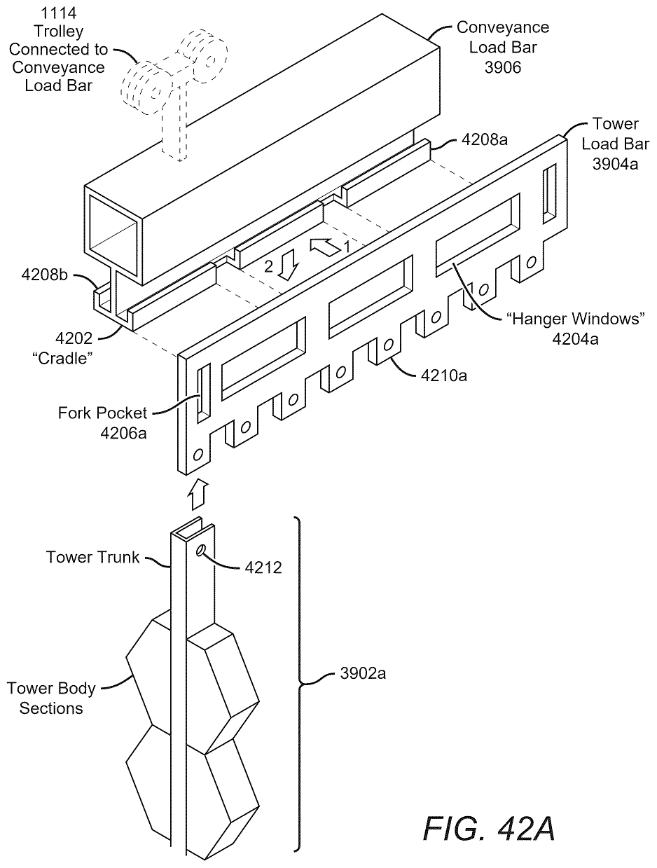

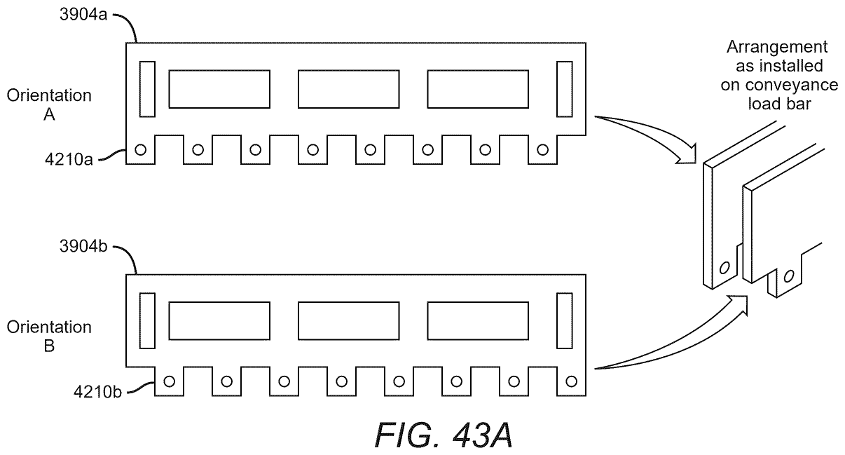

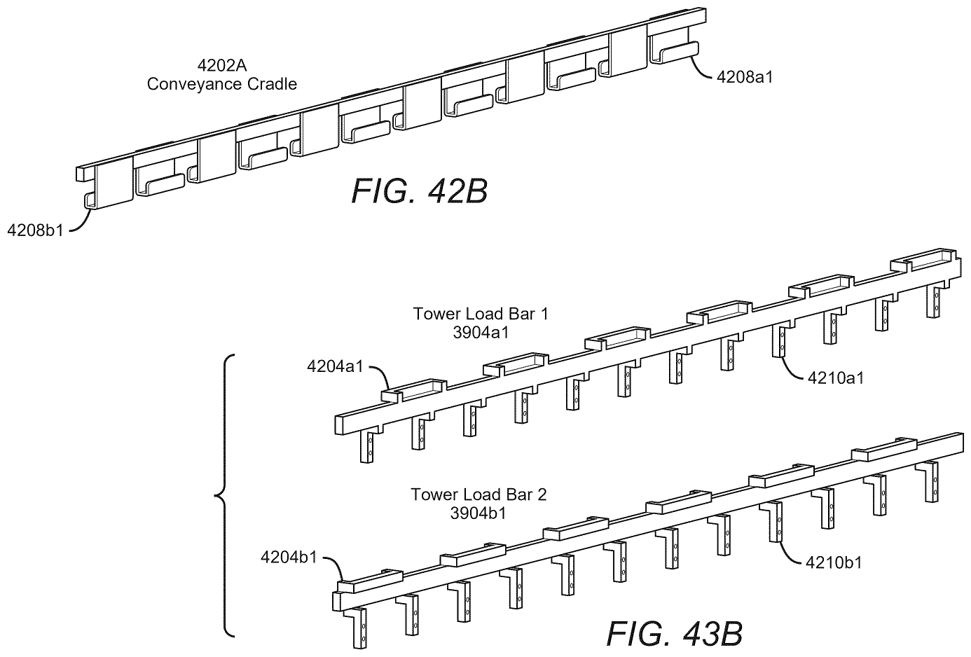

FIG. 42A illustrates details of the conveyance load bar 3906 and the tower load bar 3904a, according to embodiments of the disclosure. The conveyance load bar 3906 may include a cradle 4202. The cradle 4202 may include a hanger such as one or more hooks 4208a (e.g., integrated, laterally elongated hook-like features) that engage with one or more hanger windows (e.g., openings) 4204a of the tower load bar 3904a, so the tower load bar 3904a may hang from the cradle 4202.

Each tower 3902 may include a tower attachment feature such as a U-shaped structure with a hole 4212 that engages with a complementary tower load bar attachment feature such as a tab 4210 having a hole. When the two features are engaged, the holes align and a pin may secure them together. Other complementary attachment features, including snapping fasteners and the like may be employed.

A forklift or a robot controlled by controller 203 may engage one or more tines of a forklift fork, or one or more tines of a fork-like end effector of the robot, with a lifting point 4206a, e.g., fork pocket, of the tower load bar 3904a to translate and lower, or raise and translate, the tower load bar 3904a to respectively engage or disengage the one or more hanger windows 4204a with the one or more hooks 4208a of the cradle 4202. The cradle 4202 may include two sets of hooks 4208a and 4208b on opposite sides of the cradle 4202 so that two tower load bars 3904a and 3904b (not shown) may be attached to the cradle on opposite sides.

FIG. 43A depicts tower load bars 3904a and 3904b, with respective sets of tabs 4210a and 4210b, according to embodiments of the disclosure. Note that tabs 4210a occupy spaces corresponding to spaces between tabs 4210b and vice versa. This property enables hanging the two tower load bars 3904a and 3904b from the conveyance load bar 3906 in a 2X density arrangement with alternating towers hanging from the two tower load bars interleaved with one another. In this embodiment, tower load bar 3904b is a reverse orientation of tower load bar 3904b. Thus, the same tower load bar 3904 may be used on both sides of the cradle 4202 to achieve a 2X density by just reversing the orientation upon installation.

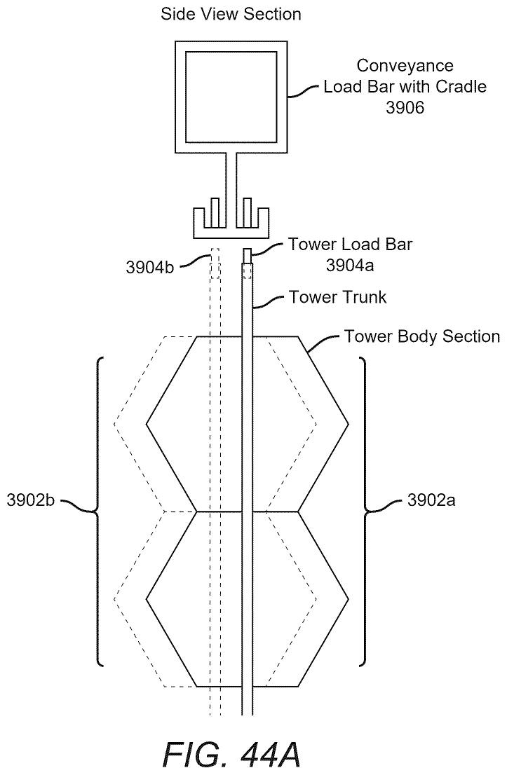

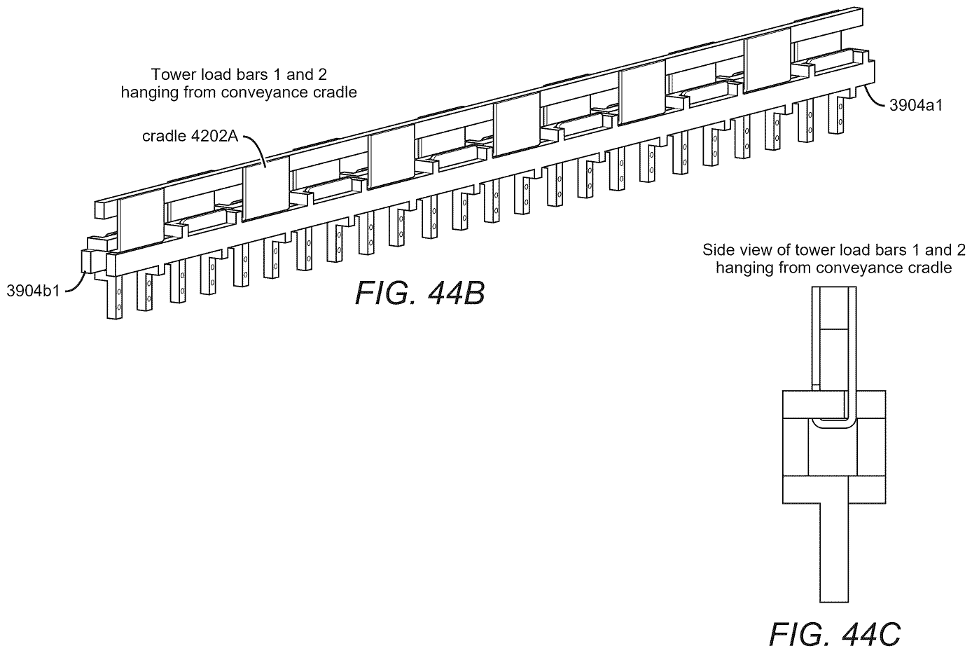

In FIG. 44, the solid lines illustrate a cross section of in-plane tower 3902a suspended from a tower load bar 3904a on one side of the conveyance load bar 3906 and the dashed lines illustrate the profile of a second out of plane tower 3902b suspended from a tower load bar 3904b on the opposite side of the conveyance load bar 3906.

Alternative conveyance cradle and tower load bars FIG. 42B illustrates an alternative conveyance cradle 4202A having alternating sets of hooks 4208a1 and 4208b1 that face in opposite directions, according to embodiments of the disclosure. One way in which conveyance cradle 4202A differs from conveyance cradle 4202 is that the assemblies of hooks 4208a and 4208b of conveyance cradle 4202 are the same with hooks 4208a and 4208b back to back, whereas the hooks 4208a1 and 4208b1 of conveyance cradle 4202A are separated and interspersed with each other.

FIG. 43B illustrates a first tower load bar 3904a1 having tabs 4210a1 for suspending towers, and a second tower load bar 3904b1 having tabs 4210b1 for suspending towers, according to embodiments of the disclosure. Tabs 4210al project outward in a first direction perpendicular to a longitudinal axis of its load bar 3904a1, whereas tabs 4210b1 projection outward in a second direction opposite the first direction.

Instead of vertical hanger windows 4204a, in this embodiment the tower load bars may have horizontally disposed apertures 4204a1 and 4204b1 to engage with the hooks 4208a1 and 4208b1, respectively, of the conveyance cradle 4202A.

In the embodiment of perspective view FIG. 44B and side view 44C, interleaved tower load bars 3904a1 and 3904b1 hang from conveyance cradle 4202A.

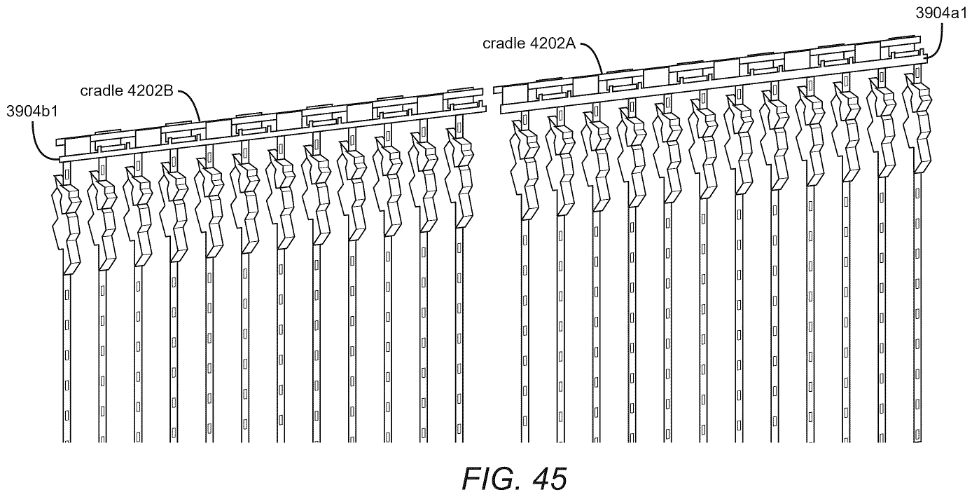

FIG. 45 corresponds to FIG. 40D using alternative embodiments of conveyance cradles and tower load bars, and shows deinterleaved tower load bars 3904a1 and 3904b1 hanging from conveyance cradles 4202A and 4202B, respectively.

### Computer System Implementation

FIG. 20 illustrates an example of a computer system 5000 that may be used to execute program code stored in a non-transitory computer readable medium (e.g., memory) in accordance with embodiments of the disclosure. The computer system includes an input/output subsystem 5002, which may be used to interface with human users or other computer systems depending upon the application. The I/O subsystem 5002 may include, e.g., a keyboard, mouse, graphical user interface, touchscreen, or other interfaces for input, and, e.g., an LED or other flat screen display, or other interfaces for output, including application program interfaces (APIs). Elements of embodiments of the disclosure, such as controller 203, may be implemented with a computer system like that of computer system 5000.

Program code may be stored in non-transitory media such as persistent storage in secondary memory 5010 or main memory 5008 or both. Main memory 5008 may include volatile memory such as random access memory (RAM) or non-volatile memory such as read only memory (ROM), as well as different levels of cache memory for faster access to instructions and data. Secondary memory may include persistent storage such as solid state drives, hard disk drives or optical disks. One or more processors 5004 reads program code from one or more non-transitory media and executes the code to enable the computer system to accomplish the methods performed by the embodiments herein. Those skilled in the art will understand that the processor(s) may ingest source code, and interpret or compile the source code into machine code that is understandable at the hardware gate level of the processor(s) 5004. The processor(s) 5004 may include graphics processing units (GPUs) for handling computationally intensive tasks.

The processor(s) 5004 may communicate with external networks via one or more communications interfaces, such as a network interface card, WiFi transceiver, etc. A bus 5005 communicatively couples the I/O subsystem 5002, the processor(s) 5004, peripheral devices 5006, communications interfaces, memory 5008, and persistent storage 5010.

Embodiments of the disclosure are not limited to this representative architecture. Alternative embodiments may employ different arrangements and types of components, e.g., separate buses for input-output components and memory subsystems.

Those skilled in the art will understand that some or all of the elements of embodiments of the disclosure, and their accompanying operations, may be implemented wholly or partially by one or more computer systems including one or more processors and one or more memory systems like those of computer system 5000. In particular, the elements of automated systems or devices described herein, such as controller 203 or drive mechanisms, may be computer-implemented. Some elements and functionality may be implemented locally and others may be implemented in a distributed fashion over a network through different servers, e.g., in client-server fashion, for example.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” the term “or” shall mean non-exclusive “or” in the manner of “and/or,” and the term “based upon” or the like shall mean “based at least in part upon,” or the like.

All references cited herein, including, without limitation, articles, publications, patents, patent publications, and patent applications, are incorporated by reference in their entireties for all purposes, except that any portion of any such reference is not incorporated by reference herein to the extent it: (1) is inconsistent with embodiments of the disclosure expressly described herein; (2) limits the scope of any embodiments described herein; or (3) limits the scope of any terms of any claims recited herein. Mention of any reference, article, publication, patent, patent publication, or patent application cited herein is not, and should not be taken as an acknowledgment or any form of suggestion that it constitutes valid prior art or forms part of the common general knowledge in any country in the world, or that it discloses essential matter.

In the claims below, a claim n reciting “any one of the preceding claims starting with claim x,” shall refer to any one of the claims starting with claim x and ending with the immediately preceding claim (claim n−1). For example, claim 35 reciting “The system of any one of the preceding claims starting with claim 28” refers to the system of any one of claims 28-34.

1. A system for transforming a first set of first plant support structures and a second set of second plant support structures from a high density arrangement to a low density arrangement,
wherein each first plant support structure includes a plurality of first plant sites, and each second plant support structure including a plurality of second plant sites,
the system comprising:
at least one actuator for deinterleaving the first and second sets to thereby move from the high density arrangement, in which the first and second sets are interleaved such that at least one second plant support structure is interposed between two first plant support structures, to the low density arrangement, in which the first and second sets are not interleaved.

2. The system of claim 1, wherein the first and second sets reside in a controlled agricultural environment.

3. The system of claim 1, comprising a first attachment member for holding together the first plant support structures of the first set, and a second attachment member for holding together the second plant support structures of the second set.

4. The system of claim 3, wherein the first attachment member comprises a first support load bar, and the second attachment member comprises a second support load bar.

5. The system of claim 3, wherein each first plant support structure includes at least one first complementary attachment member to attach to the first attachment member, and each second plant support structure includes at least one second complementary attachment member to attach to the second attachment member.

6. The system of claim 5, wherein the first and second complementary attachment members each comprise at least one hook.

7. The system of claim 3, further comprising at least one conveyance member that attaches to the first and second attachment members.

8. The system of claim 7, wherein the at least one conveyance member comprises at least one conveyance load bar.

9. The system of claim 8, wherein the at least one conveyance load bar is coupled to at least one trolley.

10. The system of claim 7, wherein the at least one conveyance member is configured to engage with and move along a conveyance line.

11. The system claim 3, wherein the at least one actuator is operably coupleable to the first and second attachment members to perform the deinterleaving operation.

12. The system claim 3, wherein the at least one actuator is operable to move the deinterleaved second set to a position behind or in front of the first deinterleaved set with respect to a direction of conveyance.

13. The system of claim 12, wherein the at least one actuator is operable to couple the moved, deinterleaved second set to engage with another conveyance member.

14. The system of claim 1, wherein the first and second plant support structures are grow towers.

15. The system of claim 1, wherein the at least one actuator comprises a robot or a forklift.

16. The system of claim 7, wherein the at least one conveyance member comprises hangers.

17. The system of claim 16, wherein each attachment member comprises at least one hanger window for engaging with one or more of the hangers.

18. The system of claim 17, wherein the second attachment member comprises the same form as the first attachment member.

19. The system of claim 7, wherein, in the high density arrangement, the first and second attachment members are arranged in reverse orientations with respect to each other on opposing sides of the at least one conveyance member.

20. A method for transforming a first set of first plant support structures and a second set of second plant support structures from a high density arrangement to a low density arrangement,
wherein each first plant support structure includes a plurality of first plant sites, and each second plant support structure including a plurality of second plant sites,
the method comprising:
deinterleaving the first and second sets to thereby move from the high density arrangement, in which the first and second sets are interleaved such that at least one second plant support structure is interposed between two first plant support structures, to the low density arrangement, in which the first and second sets are not interleaved.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. The system of claim 1, further comprising:
one or more memories storing instructions; and
one of more processors, operable coupled to the one or memories, for executing the instructions to cause the at least one actuator to deinterleave the first and second sets to thereby move from the high density arrangement to the low density arrangement.
